(19) United States
(12) Patent Application Publication
(10) Pub. No.: US 2012/0059680 A1
(43) Pub. Date: Mar. 8, 2012

(54) Systems and Methods for Facilitating Information Technology Assessments

(75) Inventors: Thomas G. Guthrie, Canton, GA (US); Julie Samantha Rachel, Alpharetta, GA (US); Kelly James Hobbie, Alpharetta, GA (US)

(73) Assignee: COX COMMUNICATIONS, INC., Atlanta, GA (US)

(21) Appl. No.: 12/874,493

(22) Filed: Sep. 2, 2010

(51) Int. Cl. G06Q 10/00

(52) U.S. Cl. 705/7.11

(57) ABSTRACT

Embodiments of the invention may include systems and methods for facilitating IT assessments. According to one embodiment, a method for representing information technology impact on an enterprise is provided. The method may include characterizing each of multiple IT applications according to multiple factors; and generating an operational impact index value for each of the IT applications based at least in part on the characterization of the respective IT application. Each operational impact index value may relate to an impact index scale representing a relative impact of the respective IT application on an enterprise.

### FIELD OF THE INVENTION

Aspects of the invention relate generally to technology assessment, and more particularly, to systems and methods for facilitating information technology assessments.

### BACKGROUND OF THE INVENTION

Over the past few decades, companies' reliance on software and information technology (“IT”) systems to support business operations has increased exponentially. As such, the costs related to procuring, developing, implementing, maintaining, and operating IT systems have grown as well. An organization or enterprise (interchangeably used herein to refer generally to any entity, operation, company, business, or other concern, any of which may generally operate or otherwise be interested in assessments of IT systems and applications) is continually faced with questions about IT costs and how to best allocate the enterprise's resources. To do so, however, enterprises need to establish a clear understanding of what IT applications are being used within the enterprise, how those IT applications are being used, costs associated therewith, future IT application phase-out planning, future IT application development planning, redundancies or overlaps between IT applications, perceptions of usefulness, worth, and effectiveness, as well as many other objective and subjective assessments of the enterprise's IT systems and applications.

Accordingly, there exists a need to facilitate performing an assessment of IT systems and applications within an enterprise.

### BRIEF DESCRIPTION OF THE INVENTION

Some or all of the above needs and/or problems may be addressed by certain embodiments of the invention. Embodiments of the invention may include systems and methods for facilitating IT assessments. According to one embodiment, a method for representing the IT impact on an enterprise is provided. The method may include characterizing each of multiple IT applications according to multiple factors; and generating an operational impact index value for each of the IT applications based at least in part on the characterization of the respective IT application. Each operational impact index value may relate to an impact index scale representing a relative impact of the respective IT application on an enterprise.

According to another embodiment, a system for representing the IT impact on an enterprise is provided. The system may include a memory operable to store computer-executable instructions and a processor in communication with the memory and operable to execute the computer-executable instructions to characterize each of multiple IT applications according to multiple factors and to generate an operational impact index value for each of the IT applications based at least in part on the characterization of the respective IT application. Each operational impact index value may relate to an impact index scale representing a relative impact of the respective IT application on an enterprise.

According to yet another embodiment, a computer program product is provided, which includes a computer usable medium having computer-executable instructions embodied therein, said computer-executed instructions operable for representing information technology impact on an enterprise by: characterizing each of multiple IT applications according to multiple factors and generating an operational impact index value for each of the IT applications based at least in part on the characterization of the respective IT application. Each operational impact index value may relate to an impact index scale representing a relative impact of the respective IT application on an enterprise.

Additional systems, methods, apparatus, features, and aspects may be realized through the techniques of various embodiments of the invention. Other embodiments and aspects of the invention are described in detail herein with reference to the description and to the drawings and are considered a part of the claimed invention.

### BRIEF DESCRIPTION OF THE DRAWINGS

Reference will now be made to the accompanying drawings, which are not necessarily drawn to scale, and wherein:

FIG. 1 illustrates an example enterprise, according to an example embodiment of the invention.

FIG. 2 illustrates an example method for assessing IT impact on an enterprise, according to an example embodiment of the invention.

FIG. 3 illustrates an example method for characterizing IT applications, according to an example embodiment of the invention.

FIGS. 4-7 illustrate example graphical representations of an enterprise as characterized, according to example embodiments of the invention.

FIG. 8 illustrates an example method for assessing IT impact on an enterprise, according to an example embodiment of the invention.

FIG. 9 illustrates an example representation of IT assessment results, according to an example embodiment.

FIG. 10 illustrates an example graphical representation of an assessment of an enterprise, according to an example embodiment of the invention.

FIG. 11 illustrates an example impact index, according to an example embodiment of the invention.

FIG. 12 illustrates an example representation of IT application variances, according to an example embodiment of the invention.

FIG. 13 illustrates an example method for assessing IT impact on various enterprise segments, according to an example embodiment of the invention.

FIG. 14 illustrates an example representation of enterprise segments, according to an example embodiment of the invention.

FIG. 15 illustrates an example representation of IT applications associated with various example enterprise segments, according to an example embodiment of the invention.

FIG. 16 illustrates an example representation of IT application assessments associated with various example enterprise segments, according to an example embodiment of the invention.

FIG. 17 illustrates an example graphical representation of an enterprise segment assessment, according to an example embodiment of the invention.

FIG. 18 illustrates an example representation of an enterprise segment assessment, according to an example embodiment of the invention.

FIG. 19 illustrates an example method for optimizing an enterprise, according to an example embodiment of the invention.

FIG. 20 illustrates an example objective function and constraint set for optimizing an enterprise, according to an example embodiment of the invention.

FIG. 21 illustrates an example starting matrix for optimizing an enterprise, according to an example embodiment of the invention.

FIG. 22 illustrates an example solution for optimizing an enterprise, according to an example embodiment of the invention.

FIG. 23 illustrates an example computer system, according to an example embodiment of the invention.

### DETAILED DESCRIPTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments described herein include systems and methods for facilitating IT systems and applications assessments within an enterprise. For example, systems and methods may be provided that analyze and indicate the impact various IT systems and applications may have on an enterprise. Generally, impact to an enterprise may be determined by first characterizing each of the IT systems and applications according to a number of objectively defined and applied factors. Then, an index is defined that provides a scale by which the impact of each of the IT systems and applications to the enterprise can be measured, and an impact index model is defined that generates a value along the index for each IT application based on the gathered characterization factor data. Example characterization factors, which are described in more detail below, may include, but are not limited to, a categorization of the lifecycle status (e.g., emerging, core, stabilized, declining, etc.) of the IT system or application, a classification of the relative “value” or “influence” the IT system or application has on the enterprise (e.g., high value, low value, medium value, etc.), and a cost or costs of the application. By mathematically and/or logically analyzing each of the IT systems and applications based on an impact index model, which depends in large part on the factor data gathered for each application, an impact value or score along the impact index continuum can be generated. Attributing an index value to each of the IT systems and applications more easily indicates the relative impact of each, such as by defining and comparing the index values to an acceptable operating range along the index and/or comparing the index values across the enterprise. Moreover, because a common index is utilized and all IT systems and applications are based on the same objectively determined factors and underlying data, the index values provide a relatively objective indication of impact to the enterprise.

In addition, according to various embodiments, the impact index can be analogized according to various “real-world” metaphors to more easily convey the relative impact of each IT system and application on the enterprise. For example, the impact index may be represented by a temperature scale, where temperatures too “cold” or too “hot” indicate more significant impact than temperatures within or near a more “comfortable” or acceptable operating range. Other example “real-world” metaphors are described below.

In some embodiments, the enterprise can be segmented into one or more enterprise segments to facilitate performing an IT impact assessment. For example, IT applications can be grouped together based on the functions the IT applications perform, the processes or business operations the IT applications are utilized for, the intended or actual end users of the IT applications, the department responsible for the IT applications, and the like. Accordingly, by segmenting the enterprise at one or more levels of abstraction, the relative impact per each segment can also be identified by associating the relative impact of the constituent IT applications to the respective segments. Analyzing the relative impact by each segment may be valuable by improving or optimizing the enterprise's IT based on a broader set of responsibilities, rather than at the individual IT application level. Moreover, improving the effectiveness, efficiency, or other operations of an entire enterprise segment may accomplish increased enterprise level operations, as compared to focusing at the discrete application level, which may not as effectively achieve enterprise-wide improvements.

After attributing an index value to applications and/or enterprise segments, a second stage of the IT assessment may include performing a mathematical optimization of the relative impacts defined, which allows providing better spending and resource allocation recommendations to the enterprise. Generally stated, adjusting factors to reduce the variances of IT applications and/or enterprise segment index values from an acceptable operating range will in turn result in a more efficiently operating enterprise overall. Various mathematical analyses can be applied to define spending and resource allocation rules and constraints, and then to determine efficient ways to allocate the resources and spending to reduce index values within, or close to, the acceptable operating range. More details of example optimization and improvement techniques are provided herein.

The terms “IT systems and applications,” “IT,” “systems,” “applications,” and any variation thereof may be used interchangeably herein to generally refer to any hardware, software, device, other IT component, or any combination or variation thereof, and are not intended to be limiting.

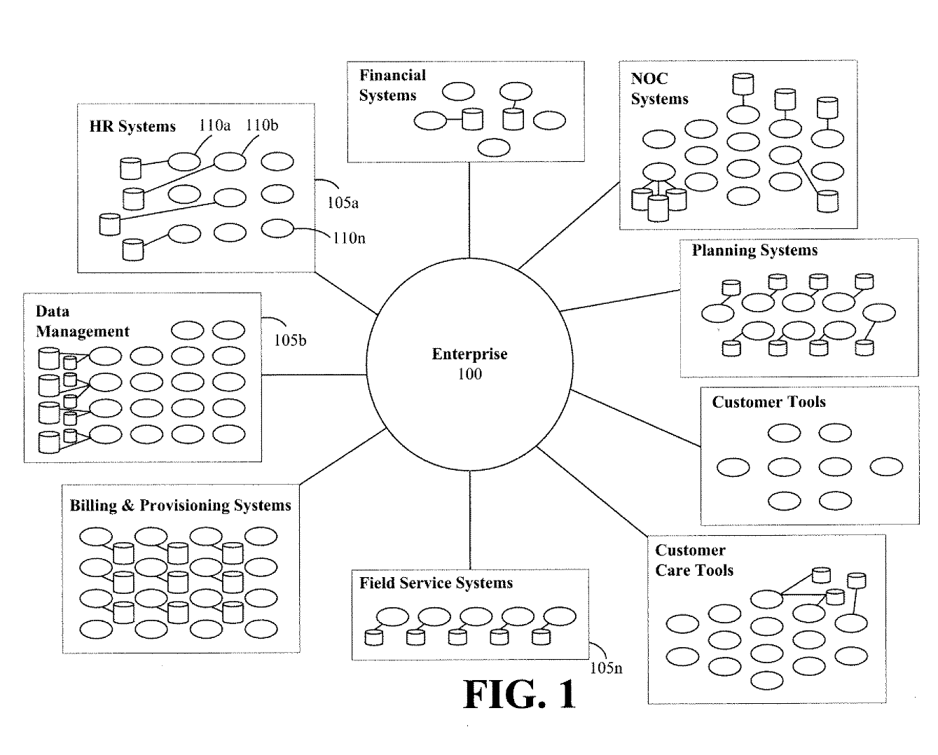

More details regarding the various means for implementing the embodiments of the invention are provided below with reference to FIGS. 1-23.

### The Enterprise

An example enterprise 100 will now be described illustratively with respect to FIG. 1; however, it is appreciated that an enterprise may have any number and types of IT systems and applications. The illustration and description with reference to FIG. 1 are not intended to be limiting.

An enterprise 100 typically includes multiple operational groups, affinity groups, divisions, segments, etc. that each perform different functions and, therefore, may utilize different IT systems. For example, larger enterprises may include a number of IT systems, each of which is configured to perform different tasks, though, some may overlap and/or provide redundant functions. In the example illustrated by FIG. 1, the enterprise 100 includes enterprise groups 105a-105n, each of which has associated with it IT applications 110a-110n. For example, the enterprise groups 105 numbered in FIG. 1 identify the human resources systems 105a, the data management systems 105b, and the field services systems 105n. Other example enterprise groups (not numbered) may include, but are not limited to, financial systems, customer service systems, billing systems, provisioning systems, customer interfacing systems, network operating center systems, planning systems, and the like. Also as shown in FIG. 1, each enterprise group 105 may utilize or otherwise be associated with one or more IT applications 110 (e.g., 110a-110n). For example, with reference to the human resources systems enterprise group 105a, the IT applications utilized may include, but are not limited to, management applications, payroll applications, payroll tax applications, workforce logic and scheduling applications, time tracking systems, commissions management applications, performance management applications, enterprise resource planning human resources applications, and the like. In some instances, an enterprise group 105 may utilize one or more IT applications 110 primarily operated or managed by, or otherwise associated with, a different enterprise group 105. For example, certain operations conducted by the field services systems 105n may utilize applications 110 primarily maintained by or associated with the data management systems 105b. Moreover, individuals generally working within one enterprise segment 105 may utilize IT applications 110 in another enterprise segment 105.

It is appreciated that the enterprise shown in FIG. 1 is provided for illustrative purposes only, and is not intended to be limiting. An enterprise may have any number and type of enterprise segments, each of which may have any number and type of IT applications associated therewith. Moreover, the details of the enterprise are not material to the systems and methods described herein, but are provided as an example context within which the systems and methods can be utilized.

### IT Assessment System—Performing the Initial IT Assessment

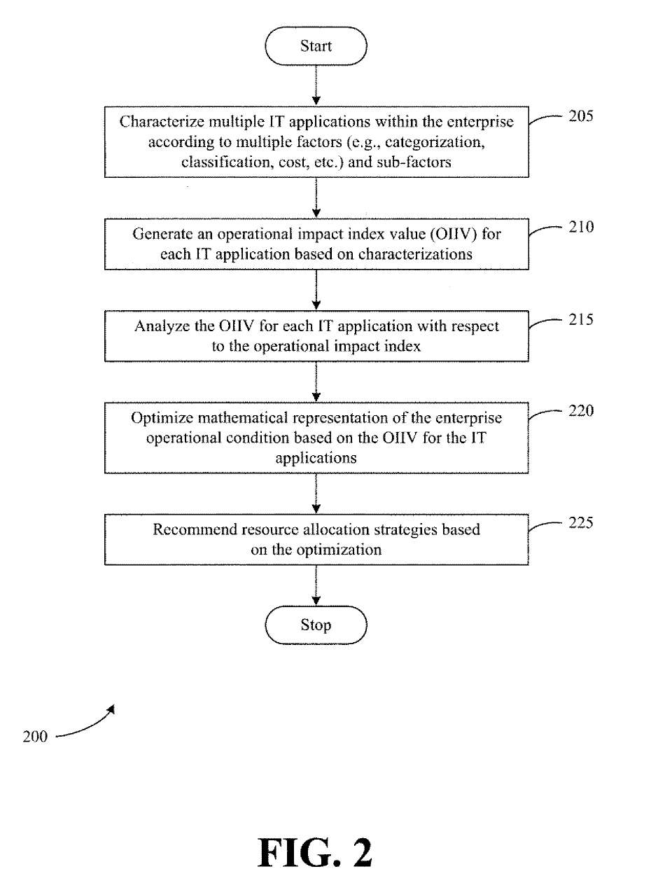

FIG. 2 illustrates a flow diagram of an example method 200 of a high-level approach for assessing and recommending improvements to IT systems and applications, such as may be performed at least in part by an IT assessment system, according to one embodiment. The method 200 may begin at block 205, in which multiple IT applications within an enterprise, such as the example enterprise 100 and IT applications 110 described with reference to FIG. 1, are characterized according to one or more factors. Characterization is performed to provide objectively defined and gathered data for each IT application, which will be utilized by an impact index model to define an index value for evaluating the impact of each application.

According to one embodiment, as described in more detail with reference to the following figures, general characterization factors may include, but are not limited to, a categorization of the lifecycle status (e.g., emerging, core, stabilized, declining, etc.) the IT application (also referred to herein as “categorizing”), a classification of the “value” of the IT application (e.g., high value, low value, medium value, etc.) (also referred to herein as “classifying”), and a cost or costs associated with the application. According to other embodiments, additional characterization factors may include, but are not limited to, the complexity associated with altering the state of the IT application, an indication of application efficiency, and the like.

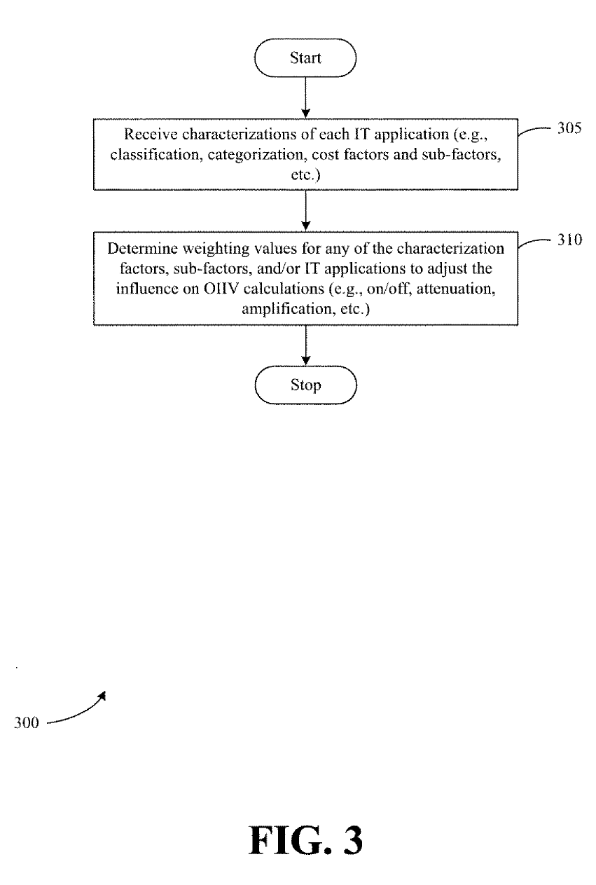

Categorization may generally be considered the indication of where a respective IT application is on a systems lifecycle continuum. An application lifecycle can be represented according to any number of statuses, such as, but not limited to: emerging, core, stabilized, and declining. Emerging applications may generally refer to those new systems that may not be fully developed or fully deployed, according to one embodiment. Core applications may refer to those systems that are fully developed and deployed, and may be important to the enterprise's operations, according to one embodiment. Stabilized applications may generally refer to those systems that meet a current enterprise need, but may be replaced at some definable time in the future, such as if the cost of improvement exceeds the value of replacement or retirement, according to one embodiment. Declining applications may generally refer to applications that are planned for replacement or retirement at some definable time in the future. Various lifecycle categories or classifications may have coefficients or factors attributable thereto that impact the resultant index value calculated to represent the relative impact caused a as a result of the given lifecycle category. For example, according to one embodiment, the previously-described example categories may have the following coefficients: emerging=1, core=2, stabilized=10, and declining=50, such that declining applications cause greater impact to the enterprise than emerging applications, and so forth. For example, as part of calculating an impact index value, separate sub-values may be defined and/or calculated for each characterization type. Accordingly, a lifecycle category sub-value may be defined as the category coefficient multiplied by any additional weighting value(s), such as are described in more detail with reference to FIG. 3.

Similarly, value or influence classification may generally be considered an additional means to represent the perceived influence an IT application has on the enterprise. According to one embodiment, the classification of each IT application may generally fall within the classifications of high impact, medium impact, or low impact. However, the underlying data to determine whether an IT application has a high, medium, or low impact may be a combination of various sub-factors defined for this analysis, and any optional weighting values attributed thereto. Example sub-factors that can be utilized to generate a classification factor may include, but are not limited to, number of system and data dependencies, user satisfaction, application effectiveness, revenue generation impact, trusted provider impact, transaction defect rate, application overlap, etc. Any number of classification sub-factors may be provided. An overall classification factor or coefficient may thus be represented by summing the product of each classification sub-factor value and any sub-factor or application weighting values.

Finally, the cost characterization factor may generally indicate the operating expenses and capital spending that contribute to the total cost of ownership and operation of an IT application. In one embodiment, cost may be represented as a unit cost, which indicates the cost to serve a single user or the cost to process a single transaction incurred by the IT application. Whether the unit cost is user or transaction dependent can be defined within the IT assessment system as appropriate for each IT application type. Example cost sub-factors may include, but are not limited to, annual hardware maintenance cost, annual hardware purchase cost, annual software maintenance cost, annual software purchase cost, support personnel cost, training cost, software and system development cost, and the like. Accordingly, an IT application total cost can be calculated by summing the product of each cost sub-factor and any sub-factor or application weighting values. The IT application unit cost is then calculated by dividing the total cost by the application usage basis (e.g., number of users supported or number of transactions supported). According to one embodiment, to better align the cost with the selected impact index scale, the application unit cost may be calibrated, such as by dividing by a constant factor which calibrates the cost values with the impact index scale used.

In other embodiments, additional or different characterization factors may be defined and utilized in the IT assessments, and any number of sub-factors for each of the overall characterization factors may further be identified and corresponding data gathered for each IT application. Accordingly, the overall characterization factors and/or sub-factors can be based on objective criteria (e.g., quantitative data, historical analysis, etc.) and/or subjective criteria (e.g., an individual's assessment of the worth or impact, the enterprise's assessment of the importance, the indication of the lifecycle status, etc.). The underlying data gathered for each of the characterization factors and/or sub-factors may be based on data gathered from the enterprise (e.g., system users, operators, managers, analysts, etc.) for each IT application.

Moreover, according to some embodiments, as illustrated in FIG. 3 by the flow diagram of the example method 300, one or more of the overall characterization factors (e.g., categorization factors, classification factors, cost factors, etc.) and/or sub-factors can be tuned or weighted such that a user and/or the system can dictate the relative influence the characterization factors and the sub-factors have on the index value generated as part of the assessment of the method 200. In addition, according to one embodiment, each IT application can also be tuned or weighted independently of other IT applications in the same or similar manner. Upon receiving the characterizations at block 305 (e.g., the same characterizations determined at block 205 of FIG. 2), the weighting values for one or more of the characterization factors and/or sub-factors can be determined at block 310. Tuning or weighting may be performed each time when conducting an IT application assessment and/or when adjusting or calibrating the IT assessment system to generate the expected outcome in line with actual, known assessments.

According to one embodiment, one or more of the overall characterization factors and/or sub-factors, and/or IT applications may be associated with “on/off switches” that allow adding or removing characterization factor or sub-factor values when calculating index value (at block 215 of FIG. 2) by the IT assessment system. These “on/off switches” are binary indicators that, when in a given state (e.g., “1” is interpreted as “on” and “0” is interpreted as “off”), indicate to the IT assessment system whether to apply the respective factor or sub-factor with which the “switch” is associated. An IT application level “on/off switch” will indicate to the IT assessment system whether the respective IT application is to be considered as part of the IT assessment, such that if the switch is set at “off” or “0,” the index value will be zero irrespective of other factor and sub-factor values and weighting values associated therewith.

In addition, according to one embodiment, one or more of the overall characterization factors and/or sub-factors may be associated with a weighting value that acts as a multiplier applied by the IT assessment system. Weighting values allow attenuating or reducing the relative influence the respective factors, sub-factors, and/or IT applications have on the enterprise. For example, a weighting value between 0 and 1 (e.g., in increments of 0.1, etc.), when multiplied by the actual value of the characterization factor, sub-factor, or IT application with which the weighting value is associated, reduces the actual value. Weighting values may also allow amplifying or increasing the relative influence the respective factors, sub-factors, and/or IT applications have on the enterprise. For example, a weighting factor greater than 1, when multiplied by the actual value of the characterization factor, sub-factor, or IT application with which the weighting value is associated, acts to increase the actual value.

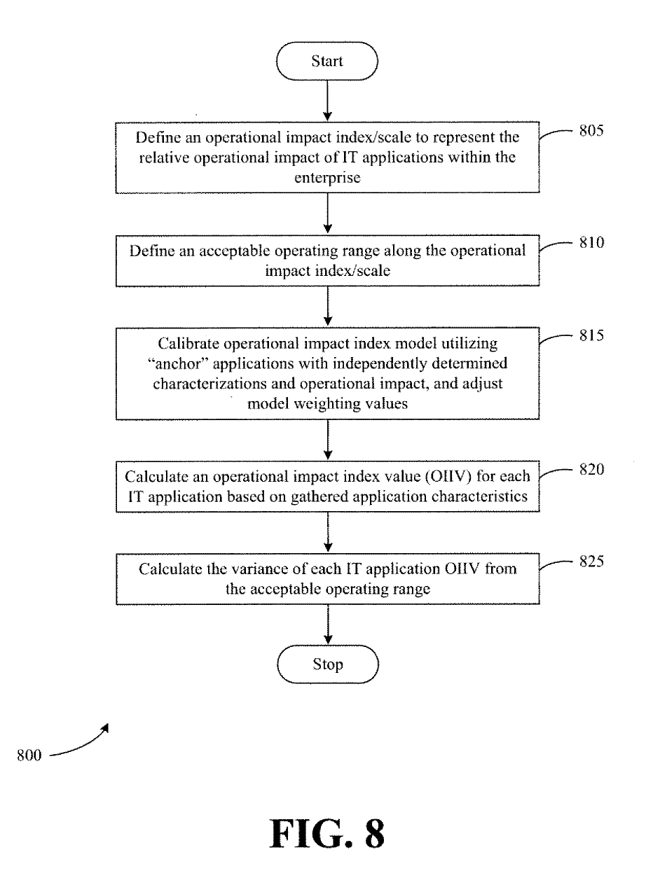

Accordingly, an IT assessment system configured to optionally apply weighting values allows emphasizing (e.g., “amplifying”) or minimizing (“attenuating” or excluding when set to “0”) the impact of individual characterization factors and/or sub-factors, as well as individual IT applications in their entirety, when analyzed by the IT assessment system. As mentioned above, weighting values can be adjusted during the initial set-up and configuration of the IT assessment system, such as when defining the actual index and associated calculations to generate index values of each IT application, which is described in more detail herein with reference to FIG. 8. In addition, weighting values can also be adjusted while performing specific index value calculations to allow a more customized analysis, with a focus on some aspects or deemphasizing other aspects.

According to one embodiment, index models and IT assessments that are based at least in part on enterprise segments, or otherwise grouped by enterprise segments, can further include segment level weighting values and “on/off switches” that allow controlling the relative level of impact each enterprise segment has on the overall assessment. Segment level weighting values operate in the same or similar manner as described for the characterization factor, sub-factor, and IT application weighting values.

With continued reference to FIG. 2, block 205 of the method 200 therefore provides for the characterization of each IT application based on a number of characterization factors and sub-factors. Characterization provides the foundation on which mathematical analyses are performed to determine an index value for each IT application. The index value is relative to an overall index or scale representing an “impact” of the respective IT application on the enterprise.

Accordingly, following block 205 is block 210, in which an index value, which is referred to herein as an operational impact index value (“OIIV”), is calculated by the IT assessment system utilizing an impact index model based on mathematical relationships between the characterizations performed at block 205. As used herein, according to different embodiments, the term “impact” may represent a “negative” impact (e.g., complexity, direct or indirect costs, opportunity costs, inefficiency, etc.), which an enterprise goal may be to correct or minimize, or a “positive” impact, which an enterprise goal may be to emphasize or increase. According to various embodiments, any relative measure of IT systems or applications on an enterprise may be analyzed utilizing the systems and methods described herein. The example of negative impact described in detail herein is provided for illustrative purposes and is not intended to be limiting.

At block 210, the IT assessment system utilizes the impact index model to perform mathematical calculations, which depend in part on the characterization values, and, optionally, on any “on/off switches” and/or weighting values, to generate an OIIV for each IT application. The mathematical calculation will depend, in large part, on the number and type of characterization factors and sub-factors, and the desired impact that each is to have in generating the OIIV. Moreover, the actual OIIV generated depends on the definition of the impact index itself, which is described in more detail with reference to FIG. 8. In one example, the index may be represented by a “real-world” metaphor to a temperature scale, whereby each OIIV calculated represents a temperature or “heat.” Thus, an acceptable operating range, which refers to the “heat” value or range of values on the index within which it is desirable that the IT applications reside, may be a “comfortable” temperature, such as between 32 degrees and 100 degrees, for example. IT applications having OIIVs outside of the operating range may be introducing too much “heat” or not enough “heat” to the enterprise. It is appreciated that the exact mathematical calculations underlying the impact index model and generating the OIIVs are not material to the scope of the systems and methods described herein. In fact, the generation of any index value based on information and data that objectively characterizes each IT application can provide the basis for the subsequent IT assessments described herein. More examples of calculated OIIVs for IT applications are provided with reference to FIGS. 8-10, for example.

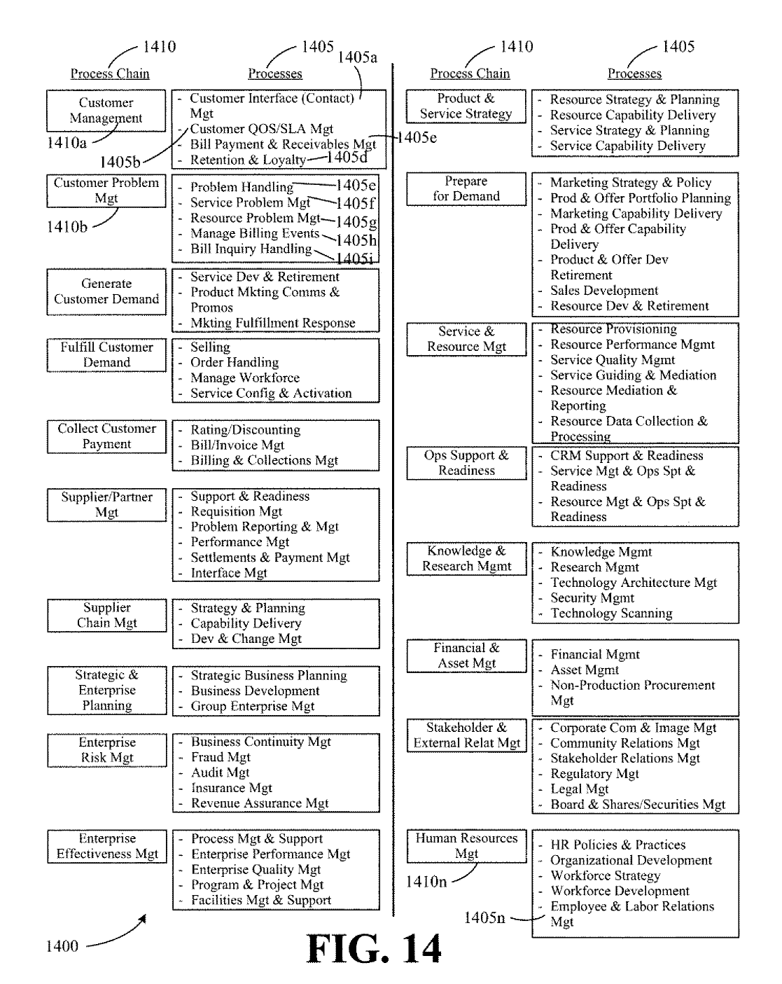

Following block 210 is block 215, in which an analysis of the OIIV for each IT application is performed. According to one embodiment, the analysis may include further calculating the OIIV for larger enterprise segments within the enterprise. For example, an OIIV may be calculated for a group of applications, such as, but not limited to, applications grouped into processes, applications associated with processes that are in turn grouped into a process chain, applications associated with an enterprise group (e.g., division, operation group, affinity group, etc.), applications grouped by function, and the like. Different example application grouping and enterprise segments are described in more detail herein, such as with reference to FIGS. 1 and 14. Accordingly, an OIIV may be calculated for any of a number of enterprise segments in addition to an OIIV for each IT application. In one embodiment, an enterprise segment OIIV may be calculated based on the sum of the individual IT application OIIVs that are associated with the respective enterprise segment. In another embodiment, an enterprise segment OIIV may be calculated as an average based on the associated IT application OIIVs. Moreover, in addition to optionally providing weighting values and/or “on/off switches” for characterization factors, sub-factors, and/or IT applications, weighting values and/or “on/off switches” can be provided at one or more enterprise segment levels. For example, in some instances, it may be desirable that the IT assessment system minimize, maximize, or eliminate the relative influence certain applications have on the enterprise segment OIIV, which can be accomplished by assigning the appropriate IT application weighting value to achieve the desired amount of impact. In another example, it may be desirable to alter the relative influence a single enterprise segment has on the overall IT assessment, which can be accomplished by assigning the appropriate enterprise segment weighting value to achieve the desired amount of impact the respective enterprise segment has on the overall assessment.

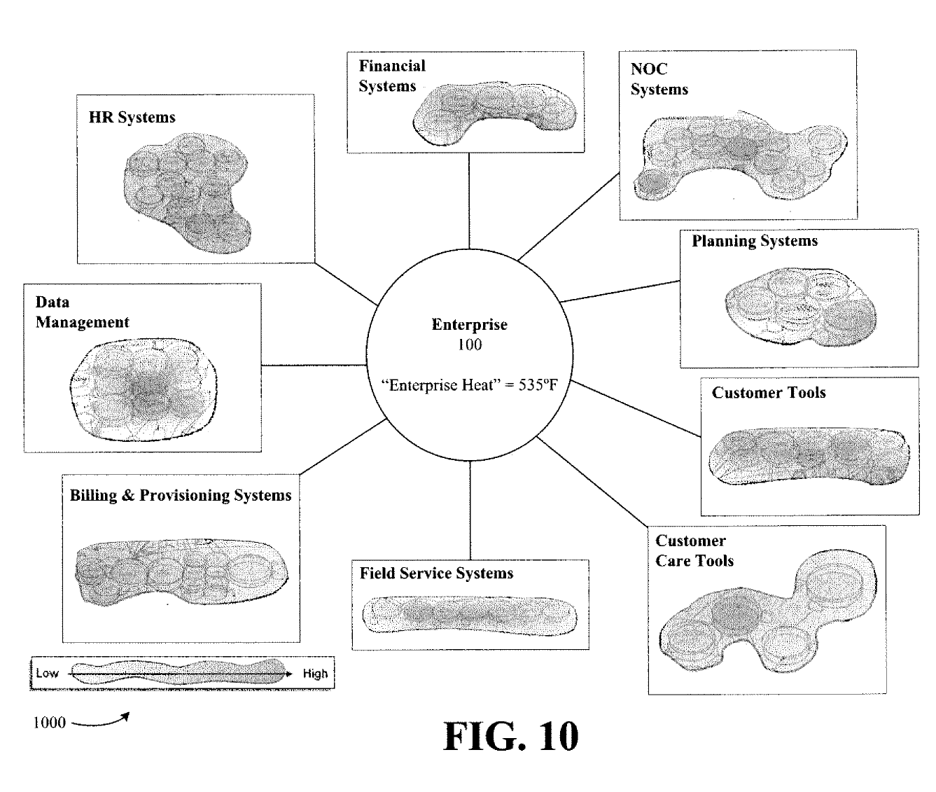

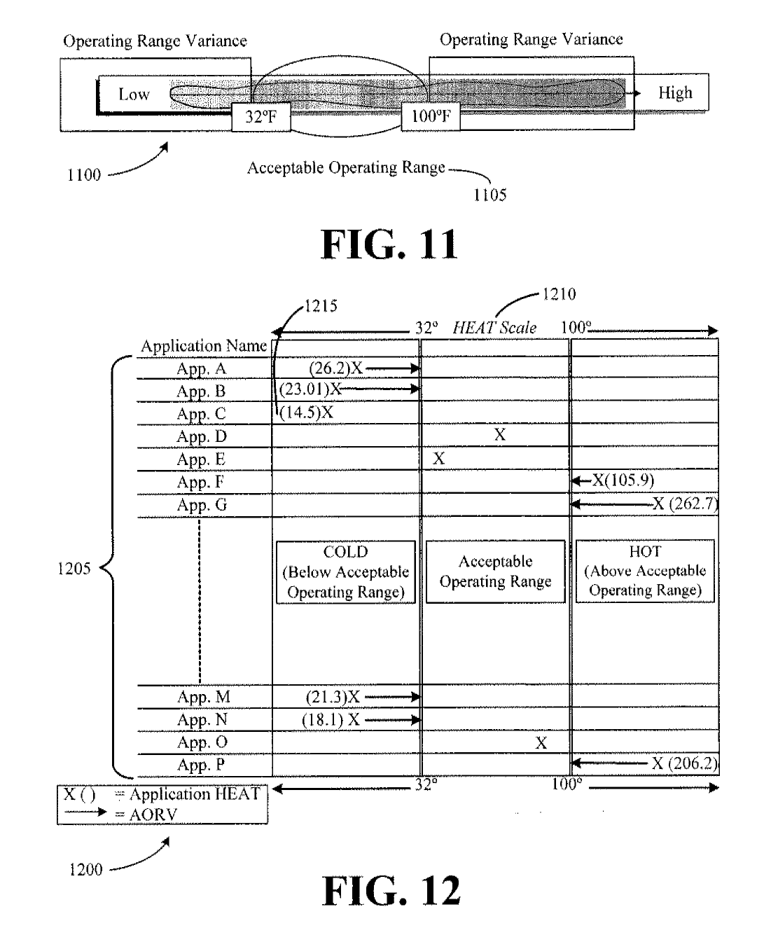

According to one embodiment, the analysis performed at block 215 further includes determining the variance of each IT application (and/or enterprise segment OIIV) with respect to a predefined acceptable operating range. The variance value therefore provides an absolute number, which is determined by the actual difference or distance from the acceptable operating range, and which represents the relative level of impact the IT application (or enterprise segment) has with respect to other IT applications. Additional example calculations and analyses of variance values are described in more detail with reference to FIGS. 11 and 12.

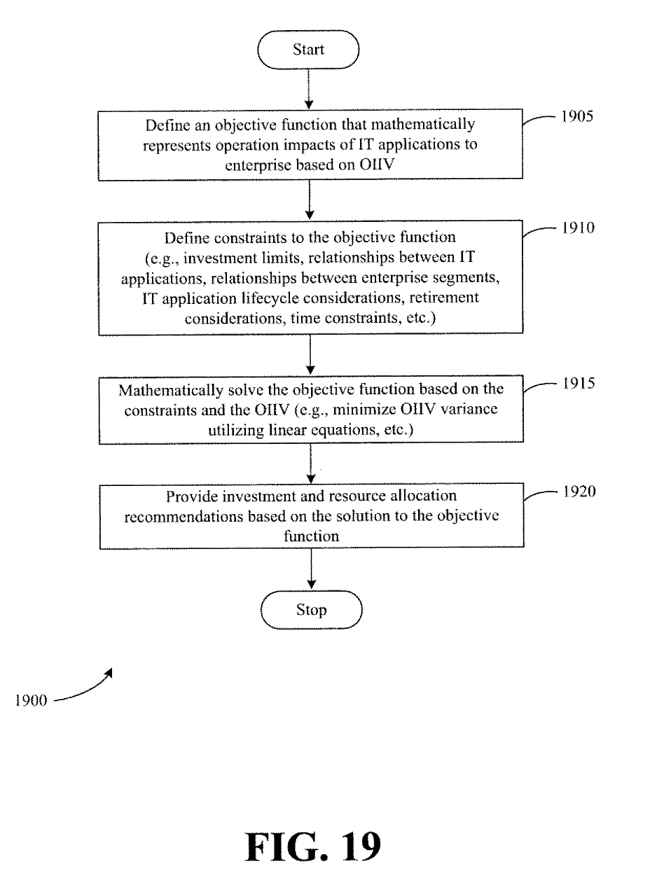

Following block 215 are blocks 220 and 225, in which the operational condition of the enterprise, based on the calculation and analyses of the OIIVs performed at blocks 210 and 215, is mathematically optimized, and IT spending and resource allocation recommendations are generated as a result. Generally, the mathematical representations of the enterprise condition used to generate the OIIVs for each IT application can be utilized to mathematically calculate the most resourceful ways to improve enterprise spending and resource allocation. For example, according to one embodiment, mathematically minimizing the variance of OIIVs will result in a more efficiently operated enterprise. To minimize the variance values, spending and resource allocation rules and constraints are defined, and then mathematical optimizations are performed, resulting in an optimized (or at least improved) enterprise condition, and, thus, identifying the most efficient ways to allocate resources and spending that result in the greatest reduction in OIIV variances. IT impact optimization is described in more detail herein with reference to FIGS. 19-22.

The method 200 may end after block 225, having characterized each IT application being analyzed, generated an OIIV for each IT application, analyzed the relative impact of the IT applications on the enterprise, and optionally identifying the optimal recommendations for IT spending and resource allocations based on a mathematical optimization of the results.

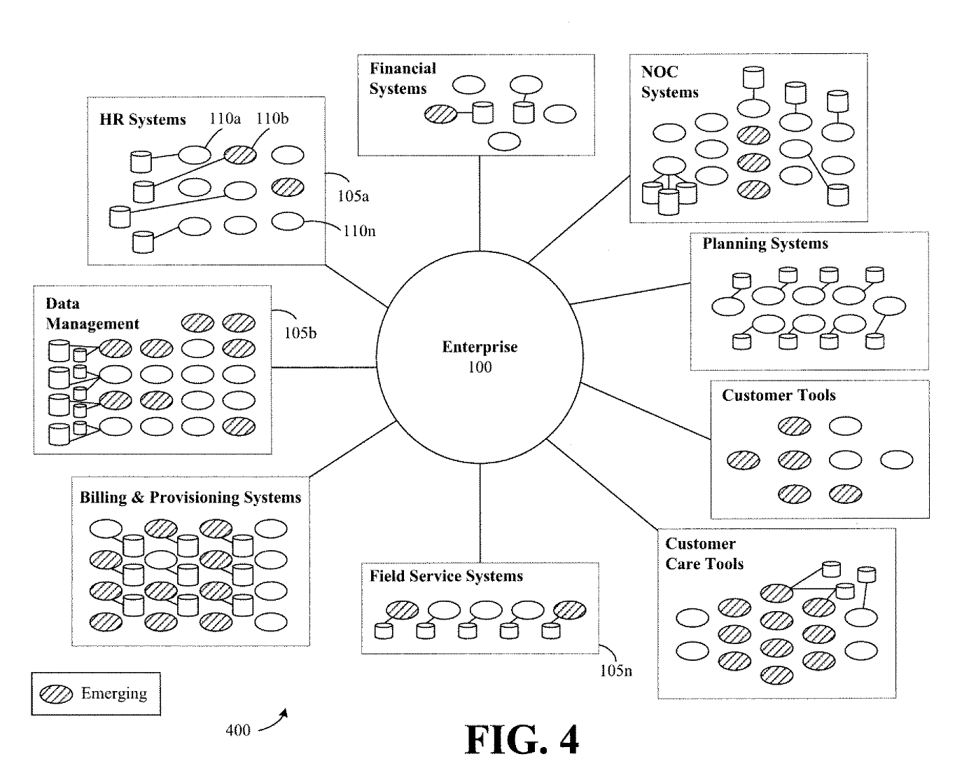

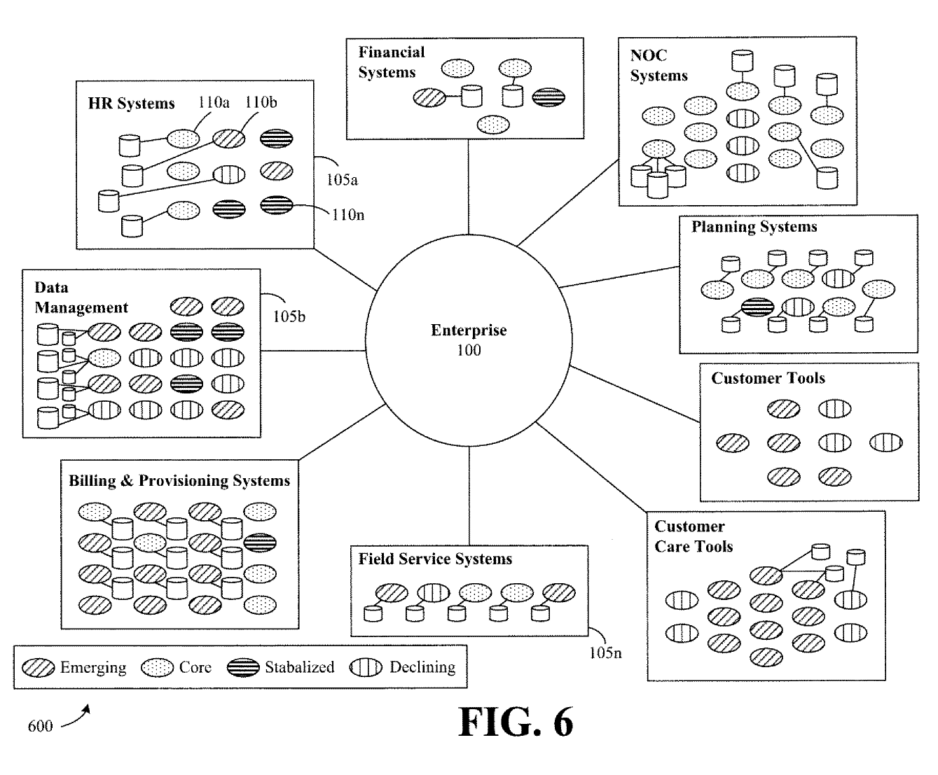

FIG. 4 illustrates a graphical representation 400 of the enterprise, highlighting the IT applications 110 within each enterprise group 105 that have been categorized to have a certain lifecycle status. In the example shown in FIG. 4, the IT applications that have been categorized as “emerging” are highlighted (e.g., shaded in this figure). For example, the human resources enterprise segment 105a has two IT applications indicated as being categorized as “emerging,” while the customer care tools enterprise segment (not numbered) only has three applications that are not categorized as “emerging.” Other lifecycle categories may include, but are not limited to, core, stabilized, declining, etc. A similar graphical representation of the enterprise 100 may be provided that indicates all lifecycle statuses, which is shown by the graphical representation 600 of FIG. 6 indicating each lifecycle status differently within a single representation. In some embodiments, the indications are based on colors that when perceived by an operator would result in a natural association with the respective statuses. For example, IT applications 110 categorized as core may be highlighted in green, IT applications 110 categorized as declining may be highlighted in red, IT applications 110 categorized as emerging may be highlighted in blue, and IT applications 110 categorized as stabilized may be highlighted in yellow. It is appreciated that, according to other embodiments, any number of other graphical indications may be utilized. Moreover, in other embodiments, instead of, or in addition to, graphical indications, text indications may be provided, such as the status itself, a numerical or alphabetical value, and the like. Generating and displaying a graphical representation of the categorization values for each IT application 110 across the enterprise 100 provides a beneficial quick view of the lifecycle, logically grouped, across the enterprise. It is further appreciated that, instead of, or in addition to, a pictorial representation of the enterprise 100, a graphical representation may simply be a chart, table, listing, etc.

According to various embodiments, the IT assessment system can generate the graphical representation 400, shown in, and/or described with reference to, FIG. 4 (and any other graphical representation described by example herein), based on data it collects at the characterization stage of performing the IT assessment. According to various embodiments, the IT assessment system can store the representation 400 in memory; transmit it to operators, end users, and/or other systems; display the representation 400 on one or more screens; print the display for hardcopy viewing; and the like. It is further appreciated that the same or similar underlying graphical representation of the enterprise, such as that illustrated in FIG. 4 (or any other representation), may serve as the basis for graphically representing subsequently identified IT assessment values (e.g., other characterizations, OIIVs, variances, relative operational conditions, etc.).

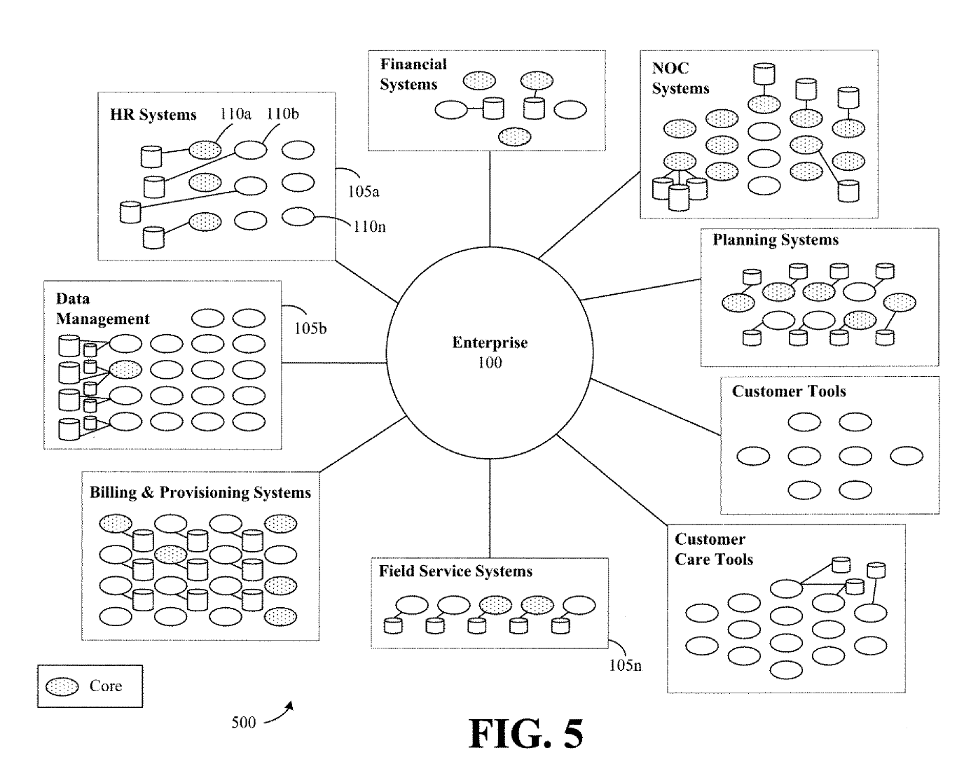

FIG. 5 illustrates a graphical representation 500 of the enterprise, similar to that illustrated by FIG. 4, highlighting the IT applications 110 within each enterprise group 105 that have been categorized as “core” applications. Similarly, FIG. 6 illustrates a graphical representation 600 of the enterprise that shows all lifecycle categorizations for all IT applications 110, which, according to this example, are emerging, core, stabilized, and declining. As shown in FIG. 6, different indications for each lifecycle categorization allow easy identification of the lifecycle statuses (e.g., different shading, patterns, colors, numbers, phrasing, etc.).

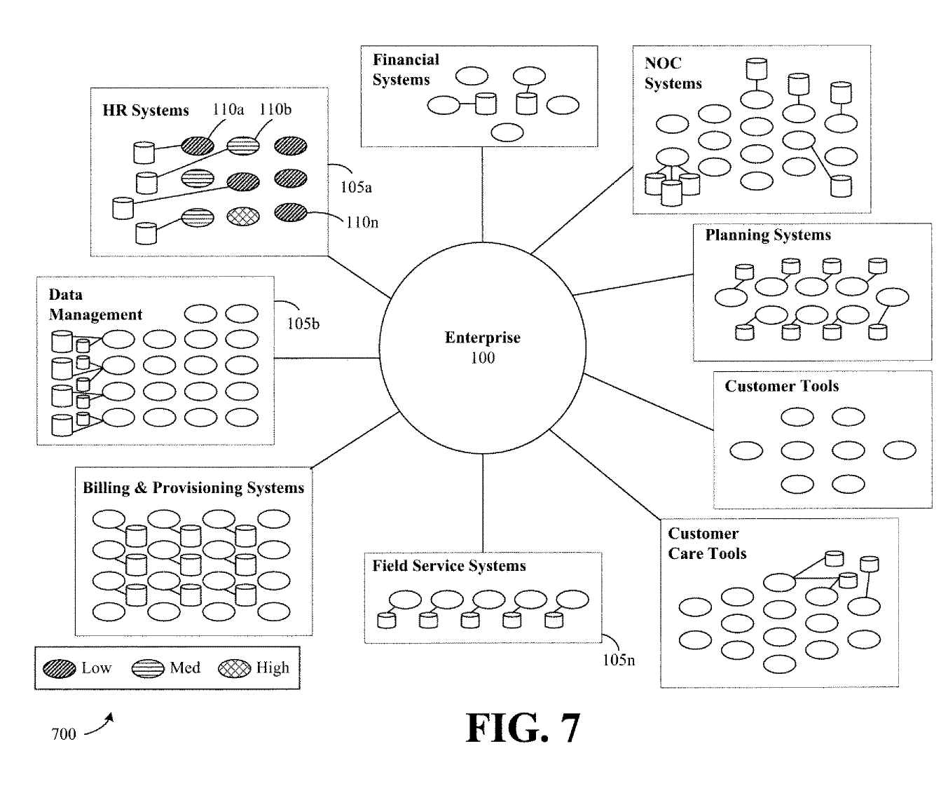

FIG. 7 illustrates another graphical representation 700 of the enterprise. According to this graphical representation 700, the classification of each IT application 110 within a single enterprise group 105a is indicated. As described above, classification may generally refer to the value or impact an IT application 110 may have on the enterprise, such as high, medium, or low. This representation 700 allows displaying all results for one characterization type within a single enterprise group 105a.

FIG. 8 illustrates a flow diagram of an example method 800 for defining an operational impact index, calibrating the IT assessment system, and determining and analyzing the OIIVs, according to one embodiment. The method 800 may begin at block 805, in which an operational impact index or scale (referred to interchangeably herein as “index” or “scale” for simplicity) is defined. The operational impact index represents a continuum along which the operational impact (measured by OIIV) of individual IT applications and/or enterprise segments to the enterprise can be measured.

According to one embodiment, the operational impact index may be defined using “real-world” metaphors to represent the scale values. “Real-world” metaphors allow graphically and/or logically conveying the relative impact and the relative position of each OIIV along the index, in a context where the relative values can be easily understood. Example analogies include, but are not limited to, heat or temperature, friction, color or hue, happiness, smoothness, or any combinations thereof. Combinations of multiple analogies may be useful, such as a temperature value and an associated color, or the relationship between increased friction representing increased heat. Heat or temperature is useful because it has both (a) color associations that lend themselves to an easily cognizable understanding by a viewer (e.g., blue represents colder temperatures on the index, red represents hotter temperatures on the index, green represents acceptable temperatures on the index, etc.) and (b) a natural, well-known scale (e.g., Fahrenheit, Celsius, Kelvin). For example, with reference to the Fahrenheit scale, temperatures below 32° F. are easily understood as “freezing,” while temperatures generally above 100° F. are uncomfortable, and those above 212° F. are “boiling.” Therefore, OIIVs along a Fahrenheit scale could easily represent those applications that are either uncomfortably “cold” or uncomfortably “hot.” Another “real-world” metaphor may include the use of the term “friction,” whereby “friction” refers to the “heat” generated by the level of impact each IT application has on the enterprise. For example, the larger the OIIV variance is from an acceptable operating range, the greater the amount of “friction” that is present in the system. In some instances, too much “friction” or too little “friction” negatively impacts the overall operational condition of an enterprise.

Following block 805 is block 810, in which an acceptable operating range along the index is defined. An acceptable operating range provides a basis that is used to gauge the relative levels of impact an IT application and/or enterprise segment has on the enterprise by whether the OIIV is within the acceptable operating range, or, if it is not, by the difference or variance from the acceptable operating range. According to various embodiments, an acceptable operating range may be a single value or one or more ranges of values. The definitions of acceptable operating ranges may vary between enterprises. In addition, the acceptable operating range may be altered or otherwise defined differently for separate assessments performed. For example, one IT assessment may be performed to identify a very narrow set of applications, such as those existing at the extreme ends of the index scale. In this example, a broader operating range would be set. In other examples, a very narrow set of high performing applications may be identified by identifying a very narrow acceptable operating range. As such, the acceptable operating range or ranges can be programmed into the IT assessment system accordingly. It is appreciated that the specific factors utilized to define the acceptable operating range are not material to the scope of that described herein, and that it may vary by implementation and the underlying goals for performing an IT assessment.

In the example using the Fahrenheit scale to represent the operational impact index, an acceptable operating range may be defined as the index values between 32° F. and 100° F., such as is shown in FIG. 11. Thus, any IT applications or enterprise segments having OIIVs above 100° F., or below 32° F., would indicate the IT applications or enterprise segments exhibit an undesirable impact on the enterprise.

Following block 810 is block 815, in which the impact index model utilized by the IT assessment system to generate the OIIV for each IT application is calibrated. Calibration may be performed by iteratively comparing and adjusting the index model output (e.g., OIIVs) based on independently established known or expected output, such as may be acquired based at least in part on independently gathered historical performance data, historical analysis, external review, and the like.

According to one embodiment, the impact index model and the operational impact scale are calibrated utilizing “anchor” applications. Anchor applications refer to any smaller group of IT applications that are independently analyzed and then assigned certain OIIVs on the operational impact index based on the independently gathered results. For example, several IT applications that are perceived to be operating acceptably, or operating with poor efficiency, excess costs, poor results, redundant, etc., are manually assigned OIIVs based on their known performance and impact on the enterprise. By manually assigning expected OIIV values for each anchor application across the index (e.g., at low points, middle points, and high points), and objectively characterizing each anchor application according to the characterization factors and sub-factors that are utilized by the impact index model, the impact index model can be adjusted or calibrated to mathematically generate the independently determined expected OIIV for each anchor application. Calibration may be performed by adjusting weighting values associated with one or more of the characterization factors, sub-factors, IT applications, or other enterprise segments. Thus, the weighting values as tuned per the anchor applications will presumably allow generating accurate OIIVs for other IT applications utilizing the calibrated impact index model.

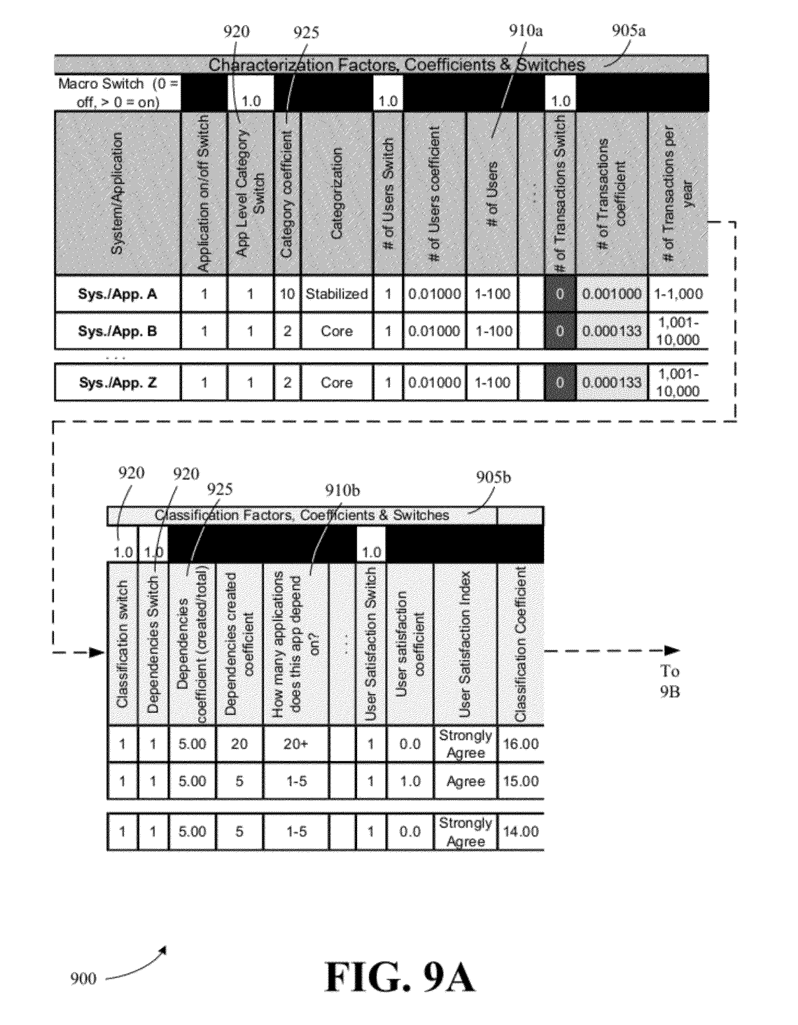

After the impact index model is calibrated and configured for performing assessments, the IT assessment system performs block 820, in which the OIIV is calculated for each IT application (and/or other enterprise segment) utilizing the calibrated impact index model, such as is described with reference to FIG. 2. FIG. 9 shows an example output 900 of the IT assessment system, showing characterization factors 905a-905n and associated sub-factors 910a-910n in column headings across the top of the output 900, and individual IT applications 915a-915n along the left column each in a row, according to one embodiment. It is appreciated that the output 900 illustrated by FIG. 9 is abbreviated for simplicity, but that any number of characterization factors and associated sub-factors, and any number of IT applications may be analyzed by the IT assessment system and output generated therefor. Each cell indicates the corresponding values for each IT application that are either gathered, calculated, or otherwise determined for each characterization factor and sub-factor. In addition, according to this embodiment, the “on/off switches” 920 and weighting values 925 are provided. In this embodiment, each “on/off switch” 920 or weighting value 925 is displayed immediately to the left of the associated characterization factor or sub-factor to which it pertains along the top of the output 900.

The output 900 also contains at least one OIIV column 930 displaying the OIIV value for each IT application, as calculated by the IT assessment system based on the index model (referred to as “HEAT” in FIG. 9). According to some embodiments, the IT assessment system may be configured to generate OIIV values for a set number of future years (e.g., for a total of five years, etc.), each of which may be displayed in the output 900. In addition to the OIIV column 930, an OIIV variance value (referred to as “operating range variance” or “ORV” in FIG. 9), which represents the difference between the OIIV value and an acceptable operating range, can be provided in an OIIV variance column 935.

Furthermore, the IT assessment system may be configured to analyze the index model and values provided therein to identify potential inconsistencies, errors, missing data, etc. These warnings may be displayed in the output 900 in one or more warnings columns 940, and may include, but are not limited to, conflicting data (e.g., unit cost basis set for both user and transaction-based calculations, etc.), missing data, entire characterization factor data missing, as well as a display of the overall confidence level for the OIIV calculations as determined by the IT assessment system.

It is appreciated that the output 900 illustrated by FIG. 9 is provided for illustrative purposes and that an IT assessment system may generate output in any number of configurations, according to other embodiments. The column headings, application labels, and values are not intended to be limiting.

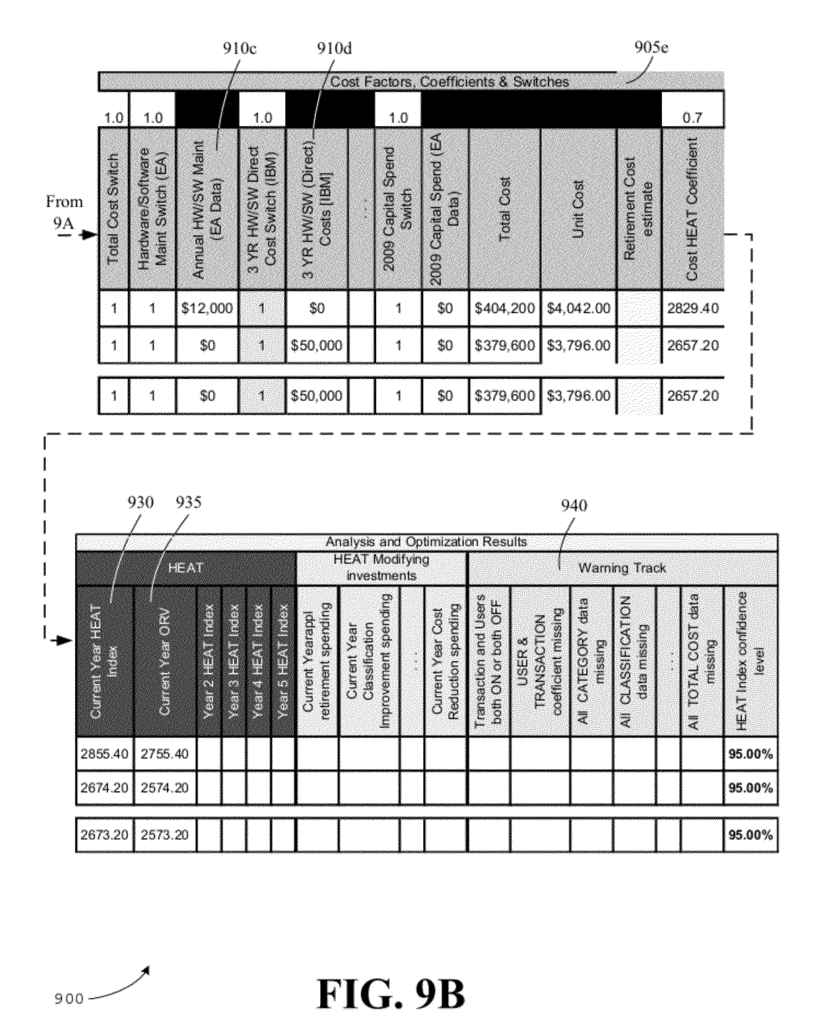

FIG. 10 illustrates an example graphical representation 1000 that illustrates the “heat” (or relative OIIVs) for each IT application and/or enterprise segment across the enterprise, according to one embodiment. According to this embodiment, the graphical representation shows the OIIVs across the enterprise, emphasizing the enterprise segments with undesirably high or low OIIVs, and those with IT applications operating within the acceptable operating range. Each application is associated with a color or shading relative to the raw OIIV calculated. Thus, when grouped, the average color or shading and gradients between each IT application are illustrated for the group. For example, with reference to the example human resources enterprise segment, there are quite a few applications with higher OIIVs relative to the rest of the enterprise. Similarly, looking at the data management enterprise segment, a single IT application appears to have significantly higher impact relative to the other applications within the group. On the other hand, the field service enterprise segment includes a few IT applications having low OIIVs, and a few having high OIIVs, which likely generates an acceptable result for the overall enterprise segment.

In addition, the graphical representation 1000 also shows a single “Enterprise Heat” (which relates to the OIIV, using the temperature metaphor) of 535° F. According to one embodiment, enterprise level values are determined based on raw OIIVs (e.g., summing, averaging, etc.). In another embodiment, the enterprise level values may be based on variances of the raw OIIVs from the acceptable operating range, such that the overall goal would be to minimize the enterprise level value, which may be accomplished by minimizing the enterprise segment values and/or application values.

It is appreciated that the graphical representation 1000 is provided for illustrative purposes, and that any number of representations may be generated by the IT assessment system and utilized to convey enterprise operational performance, according to various embodiments.

With continued reference to the method 800 of FIG. 8, after generating an OIIV value for each IT application, block 825 is performed, in which the variance of each IT application OIIV from the acceptable operating range is calculated. As discussed herein, a variance value can be used to represent the amount that each IT application and/or enterprise segment is outside of, or away from, the acceptable operating range defined at block 810. According to one embodiment, the variance may be calculated as the difference between the calculated OIIV and the nearest bound of the acceptable operating range, either the upper bound of the acceptable operating range or the lower bound of the acceptable operating range. For example, an equation for calculating the variance may be, but is not limited to: Variance=Absolute Value|Nearest acceptable operating range endpoint−OIIV|. In other embodiments, the variance may be calculated from a midpoint or other value along the impact index, such as a predefined optimum value.

FIG. 11 shows an illustrative representation 1100 of an impact index based on the Fahrenheit scale and having an acceptable operating range 1105 defined between 32° F. and 100° F. Accordingly, the IT applications having OIIVs calculated to be lower than 32° F. will be depicted to the left of the acceptable operating range, while the IT applications having OIIVs calculated to be greater than 100° F. will be depicted to the right of the acceptable operating range. The variance of each IT application will be calculated as the absolute value of either 100° F. or 32° F. minus the OIIV; the farther the OIIV is from either 100° F. or 32° F., the greater the variance.

FIG. 12 shows an example output 1200 of IT application variances on an impact index 1210 based on the Fahrenheit scale. Accordingly, a list of IT applications 1205 is provided with an “X” indicating the raw OIIV and the variance 1215 in parentheses next to it. For example, for the sample “App. A” IT application, the OIIV is determined to be 5.8 by the IT assessment system, and the variance is calculated as 26.2 accordingly. Similarly, the sample “App. G” IT application has an OIIV of 362.7 and a variance of 262.7. Thus, in this example, relative to the other sample applications, the “App. G” sample IT application appears to cause the greatest operational impact to the organization, while the “App. D,” “App. E,” and “App. O” each have OIIVs within the acceptable operating range (between 32° F. and 100° F.). Also indicated by the output 1200 is the concept of applications being too “cold” or too “hot” if they are below or above the acceptable operating range, respectively, thus causing operational inefficiencies or other undesirable impact to the enterprise.

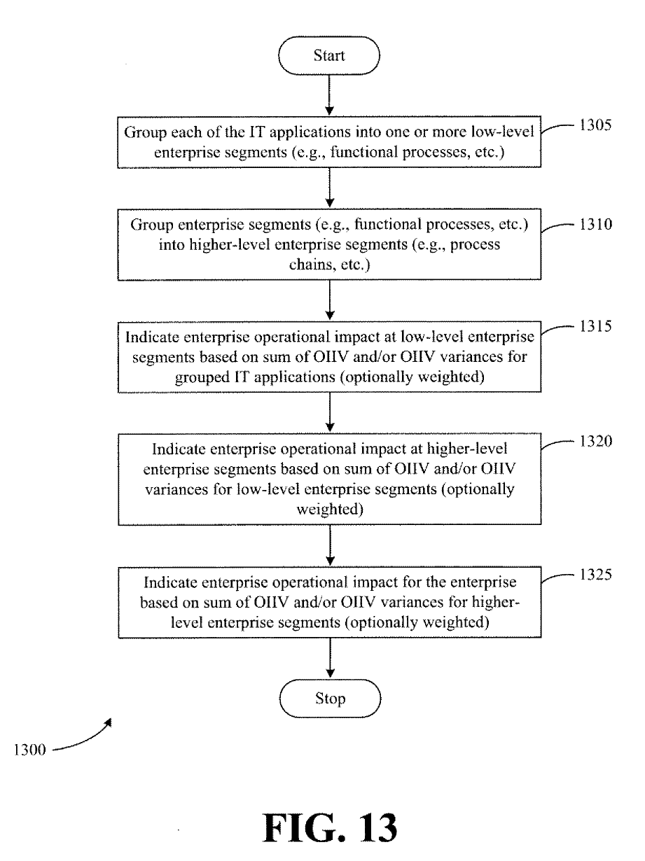

Accordingly, one goal may be to minimize the relative impact (e.g., minimize the “heat” or “friction”) across the enterprise, thus improving the overall operational efficiency. With reference to FIGS. 11 and 12, this would entail investing in IT applications (and/or at higher levels of enterprise segmentation) to reduce the variances, or bringing applications within or closer to the acceptable operating range (e.g., closer to the range of 32° F. to 100° F.), which is described in more detail with reference to FIG. 13.

The method 800 may end after block 825, having defined and calibrated the impact index model and determined an OIIV and variance from an acceptable operating range for each IT application analyzed. Calculating the variance for each IT application allows further analyses to be performed utilizing the application variances and/or raw OIIVs to determine the operational performance at various enterprise segment levels and/or at the enterprise level.

FIG. 13 illustrates a flow diagram of an example method 1300 for analyzing the operational impact at different levels of the enterprise, such as may be performed, at least in part, by an IT assessment system. As described above, the enterprise can be segmented according to various levels of abstraction or enterprise segmentation, allowing logical grouping and, thus, analyzing enterprise behavior by enterprise segments. According to one embodiment, the enterprise can be grouped according to more than one level of enterprise segmentation. For example, IT applications can be grouped together and associated with one of multiple low-level enterprise segments, and one or more low-level segments can then be grouped together and associated with one of multiple higher-level segments. The enterprise, thus, can be represented by multiple higher-level segments, each of which have associated low-level segments, which are in turn associated with multiple IT applications. It is appreciated that an enterprise may be segmented in any number of ways and by any number of levels of segmentation. The three-level segmentation described herein (e.g., IT applications, low-level segments, higher-level segments, etc.) is provided for illustrative purposes only. Therefore, by determining OIIVs for the constituent IT applications and analyzing the OIIVs, variances, and/or other impact indicators at each level of segmentation allows analyzing the enterprise operational performance at various levels of abstraction.

According to one embodiment, low-level segments may be defined based on IT applications or systems performing similar functions and/or serving similar goals. These low-level segments may be referred to as “process segments.” Each process segment may then be associated with one or more higher-level enterprise segments referred to as “process chain segments,” each of which refers to a grouping of related process segments that, together, represent groupings of operations, functionalities, and/or results that define certain operating aspects of the enterprise. Accordingly, IT applications can be grouped with one or more process segments, each of which are in turn grouped within a respective process chain. According to various embodiments, it is possible that a single IT application is associated with multiple process segments and/or that a single process segment is associated with multiple process chain segments.

Enterprise segment definitions may be defined utilizing common or otherwise available process definitions. For example, process segment and process chain segment definitions may be based at least in part on common industry-specific process definitions. According to one embodiment, some or all of the enhanced Telecom Operations Map (“eTOM”) process definitions for the telecommunications industry (e.g., levels 0 through 3) produced by the TeleManagement Forum (“TM Forum”) can be utilized at least in part to define process segments, as well as to further define the grouping of process segments into process chain segments. It is appreciated that other industry-defined process definitions or other operational organization definitions may be utilized to facilitate segmenting the enterprise. According to other embodiments, the enterprise segment definitions may be internally defined by the enterprise, be specific to the enterprise, and at least in part be independent of third-party or commonly known definitions.

Accordingly, in one embodiment, each of the IT applications being analyzed are grouped or otherwise associated with one or more low-level enterprise segments (e.g., process segments) at block 1305. At block 1310, each of the low-level enterprise segments are grouped or otherwise associated with one or more higher-level enterprise segments (e.g., process chain segments). In some embodiments, there may be fewer or greater levels of segmentation, performed in the same or similar manner as is described with reference to blocks 1305 and 1310.

FIG. 14 illustrates an example enterprise segmentation 1400, showing two columns of process segments 1405, which are in turn associated with corresponding process chain segments 1410, according to one example embodiment. As an example, the customer management process chain segment 1410a may have multiple process segments 1405 associated therewith, including the customer interface management process segment 1405a, the customer quality of service/service level agreement management process segment 1405b, the bill payment and receivables management process segment 1405c, and the retention and loyalty process segment 1405d. The customer problem management process chain segment 1410b may be associated with the problem handling process segment 1405e, the service problem management process segment 1405f, the resource problem management process segment 1405g, the management billing events process segment 1405h, and the bill inquiry handling process segment 1405i. According to various embodiments, enterprise segmentation can be defined according to any number of process segments 1405n and any number of corresponding process chain segments 1410n, and, optionally, defined according to any number of levels of segmentation.

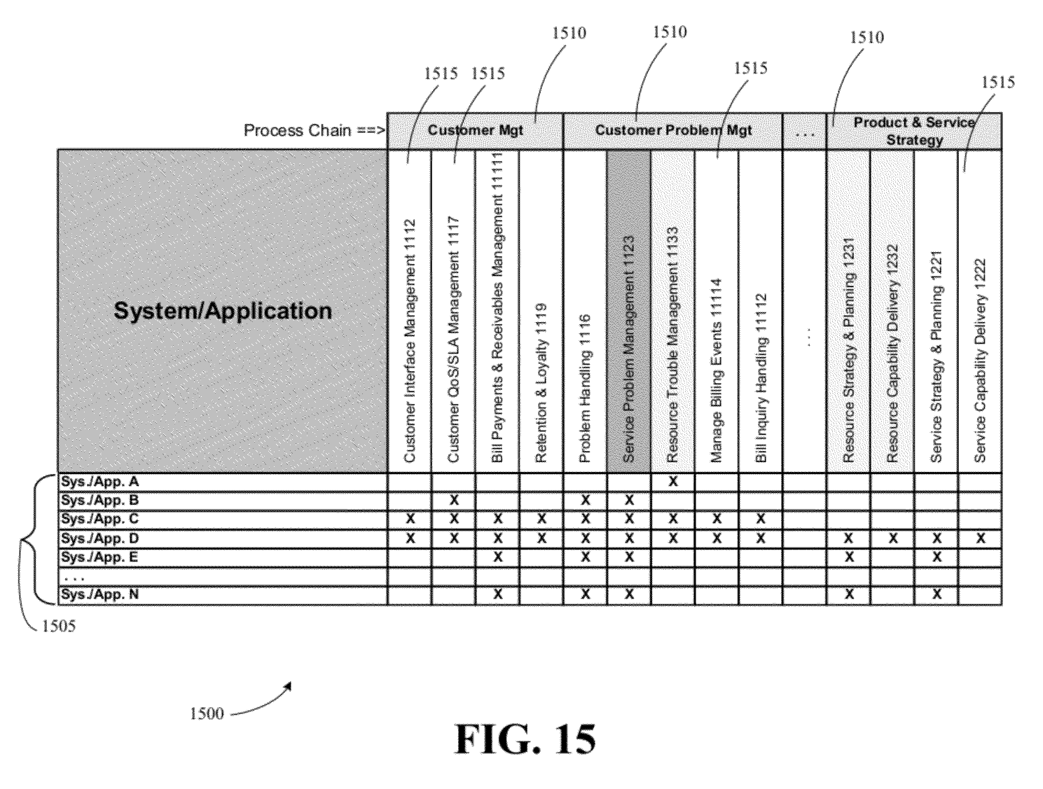

FIG. 15 illustrates another example enterprise segmentation 1500 that shows the associations between IT applications 1505, process segments 1510, and process chain segments 1515. The “X” entries in the chart indicate the process segments 1510, and thus the process chain segments 1515, with which each IT application 1505 is associated.

With continued reference to FIG. 13, following block 1310 is block 1315, in which the operational impact on the enterprise is indicated according to the low-level enterprise segments. The operational impact of the low-level enterprise segments may be indicated by mathematically representing the cumulative operational impact of the IT applications associated with each low-level enterprise segment. According to one embodiment, the raw OIIVs for each IT application associated with a low-level enterprise segment (e.g., a process segment) are summed together to indicate a total OIIV for the respective low-level segment. According to another embodiment, instead of, or in addition to, summing the raw OIIVs, an average OIIV is calculated. In yet another embodiment, instead of, or in addition to, representing OIIVs, the OIIV variances for each IT application are summed and/or averaged for the respective low-level segments. Moreover, according to one embodiment, one or more of the IT application OIIVs and/or OIIV variances can be weighted, as desired, to allow increasing or reducing the relative operational impact the respective IT application has on the low-level enterprise segment.

In a similar manner, according to one embodiment, another type of weighting value, which can be referred to as a “modeling factor,” can be applied at the enterprise segment level, such that the computational outcome for each low-level enterprise segment can be affected uniformly. In one embodiment, the low-level weighting value may be referred to a “process modeling factor,” referring to the “process” type enterprise segments. Modeling factors allow adjusting the results of a segment level computation, such as if they are too high or too low relative to other results, to minimize the dominating effect the segment or variance type may have on the overall analysis. For example, if calculating low-level enterprise variances (or other segment variances, etc.) result in numbers that are very large relative to other calculations, a modeling factor can be applied to re-adjust the results so as to preserve the sensitivity of the analysis to other factors as well. Although, in some instances, applying modeling factors at more than one level of the analysis (e.g., at the low-level and at the higher level calculations) may be counterproductive and undesirably skew the overall analysis results. Thus, in some embodiments, it may be desirable to apply modeling factors at only one or a few of the levels of the calculations, rather than a majority or all of the levels.

According to one embodiment, the operational impact of the low-level enterprise segment (e.g., a process segment) may be determined according to the following equation indicating the process level variance:

For each process j,

$$containing application i = \{ 1 , N \} , \\ Process {variance}_{j} = {Process}_{j} weight * Process modeling {factor}_{j} {\sum }_{i = 1}^{N} {( IT application OIIV variance )}_{ij} .$$

A similar equation may be utilized to indicate a raw process level OIIV, utilizing the My instead of the OIIV variance for each IT application.

Following block 1315 is block 1320, in which the operational impact on the enterprise is indicated according to the higher-level enterprise segments. Higher-level operational impact may be indicated by mathematically representing the cumulative operational impact of the low-level enterprise segments associated with each higher-level enterprise segment, in the same or similar manner as described with reference to low-level enterprise segments at block 1315. For example, the operational impact of the higher-level enterprise segment (e.g., process chain level) can be determined according to any number of mathematical operations performed on the impact determined for the corresponding underlying low-level enterprise segments and/or IT applications. For example, a sum, average, or other distribution of the respective raw OIIVs and/or OIIV variances can be performed.

According to one embodiment, the operational impact of the higher-level segment (e.g., process chain segment) can be utilized to convey a value or values that synthesize or blend the weighted OIIV variances of the underlying process segments that represent the distributions of those underlying variances across the process chain. For example, according to one embodiment, a uniform distribution can be utilized to average the underlying process OIIV variances according to the following equation indicating the process chain level variance:

For each process chain k, containing processes

$$j = \{ 1 , M \} , \\ Process chain {variance}_{k} = Process {chain}_{k} modeling factor * Process {chain}_{k} weight * 1 / M {\sum }_{j = 1}^{M} ( Process {variance}_{jk} ) .$$

In this equation, the process chain weight can optionally be utilized to allow weighting individual process chains, the process chain modeling factor can optionally be utilized to allow weighting all process chain impacts by the same amount, and the process variance is calculated in the same or similar manner as described with reference to block 1315. It is appreciated that any number of similar mathematical representations can similarly convey the distribution of the underlying low-level impact values, such as, but not limited to, Chi-squared distribution, F-distribution, student's t-distribution, and the like.

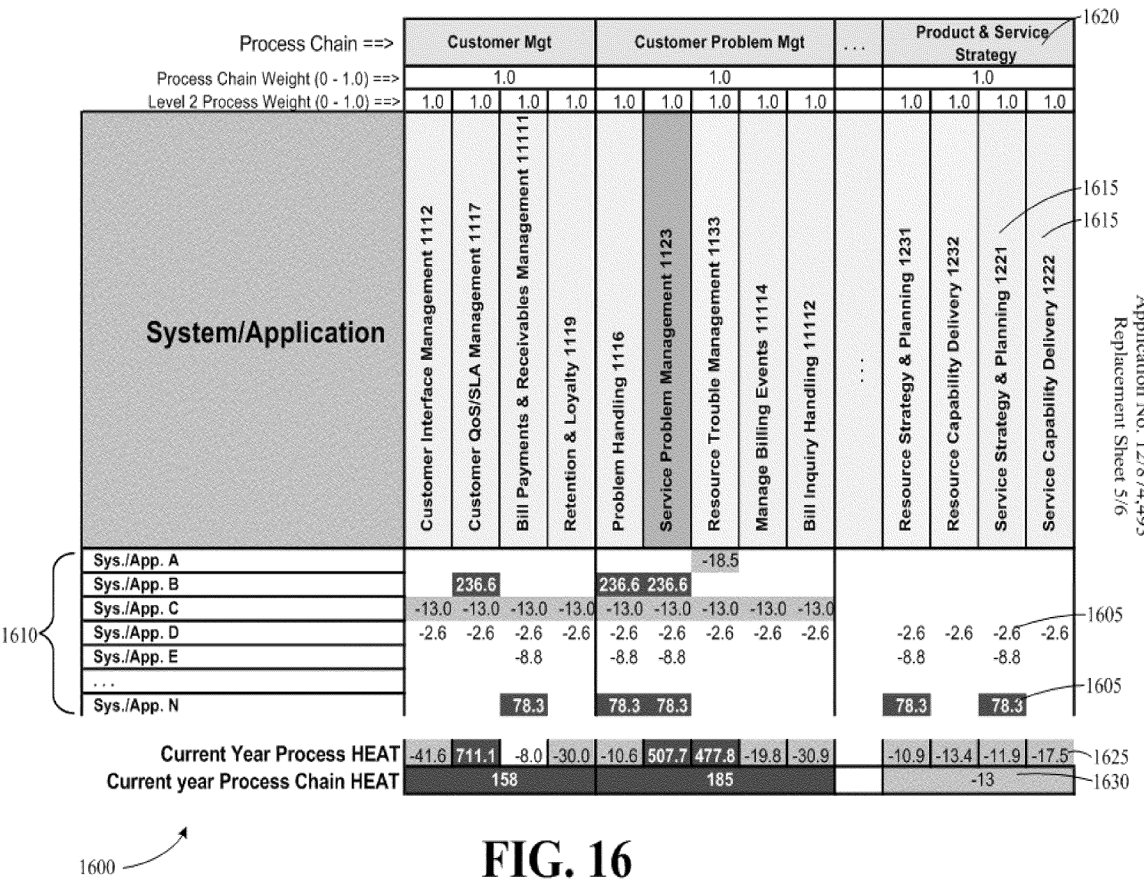

FIG. 16 illustrates an example IT assessment output 1600 displaying the OIIV variances 1605 calculated for each of the IT applications 1610 and indicating the associated with the process enterprise segments 1615. Furthermore, each process enterprise segment 1615 is associated with a process chain enterprise segment 1620 in much the same or similar manner as shown and described with reference to FIG. 15. At the bottom of the output 1600, the OIIV variances 1605 attributed to each process enterprise segment are summed to provide the process level variances 1625 (e.g., as described with reference to block 1315 of FIG. 13). In addition, the process level variances are summed to provide the process chain level variances 1630 along the bottom (e.g., as described with reference to block 1315 of FIG. 13). Also, according to one embodiment as shown, the OIIV variances 1605, process level variances 1625, and process chain level variances 1630 may optionally be shaded (or include other graphical indications) to allow quick representation of the relative impact based on the displayed OIIV variance values.

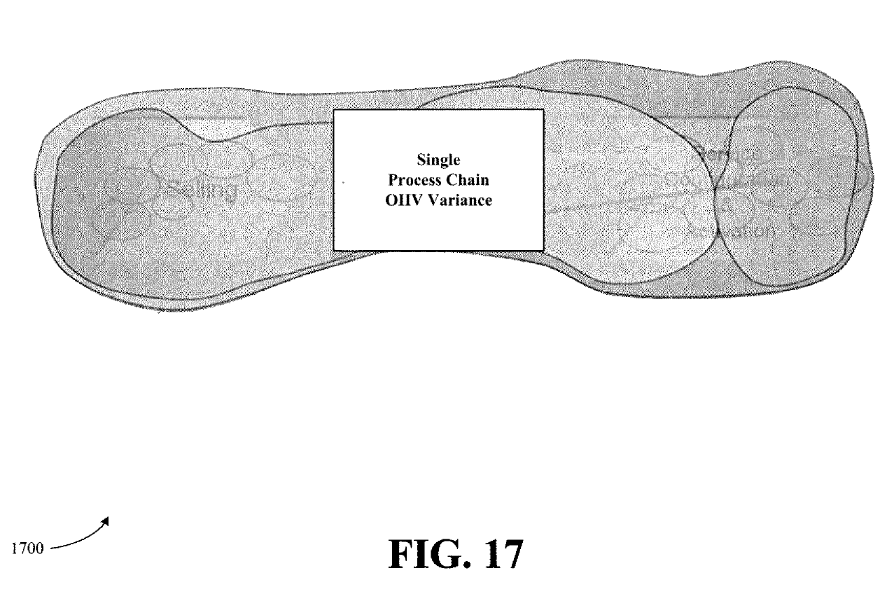

FIG. 17 shows a sample graphical display 1700, which illustrates a process chain level variance for a single process chain, also showing the gradations between the OIIVs and/or variances of the underlying processes and IT applications. This graphical display 1700 allows visually indicating the operational impact of a single process chain, while also showing the contribution of the individual process and/or IT application to the process chain's operational impact. It is appreciated that similar displays may be utilized to indicate the operational impact of higher- or lower-level enterprise segments than the process chain level represented therein by FIG. 17.

With continued reference to FIG. 13, following block 1320 is block 1325, in which the enterprise level operational impact can be indicated based at least in part on the underlying higher-level impact values, low-level impact values, and/or IT application impact values determined at blocks 1315 and 1320. Enterprise operational impact may be indicated by mathematically representing the cumulative operational impact of all of the higher-level enterprise segments, in the same or similar manner as described with reference to the determination of the higher-level operational impact and/or the low-level operational impact at blocks 1320 and 1315, respectively. For example, a sum, average, or other distribution of the respective raw OIIVs and/or OIIV variances can be performed.

According to one embodiment, the enterprise operational impact may be determined as the sum of each higher-level operational impact value (e.g., process chain variance), which may optionally be weighted. One example equation representing the enterprise operational impact may be:

For an enterprise containing k higher-level segments (e.g., process chains),

$$Enterprise variance = {\sum }_{k = 1}^{P} Process chain {variance}_{k} .$$

In this equation, process chain variance may be calculated in the same or similar manner as described with reference to block 1320.

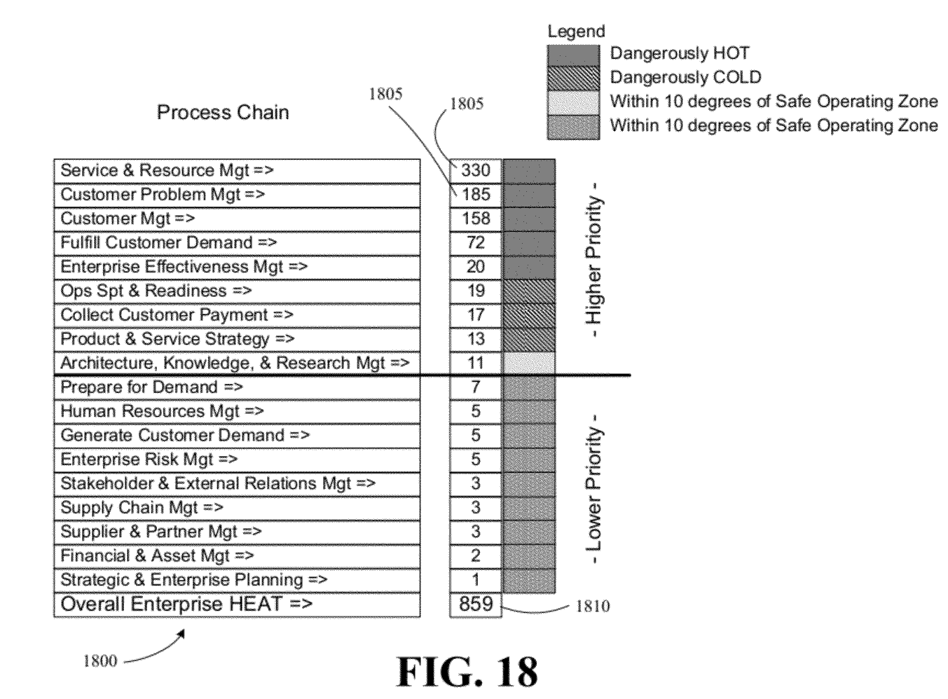

FIG. 18 illustrates an output 1800 with a different layout of process chain level variances 1805, which are summed to show the enterprise variance 1810. In addition, next to each process chain level variance 1805 is a graphical indicator, which may be represented by a color, a pattern, a number, etc., that graphically indicates whether the associated index values together are greater than (e.g., too “hot”) or less than (e.g., too “cold”) the predefined acceptable operating range. Providing an output 1800 like that illustrated by FIG. 18 allows quickly indicating which enterprise segments should be given priority by ranking and graphically displaying those that are causing a greater negative impact to the enterprise relative to the others. A similar output may be utilized to indicate raw OIIVs and impact values (e.g., raw OIIVs and/or Oily variances) at different levels of segmentation (e.g., at the process level or at the IT application level, etc.).

Accordingly, the method 1300 may end after block 1325, having segmented the enterprise into a number of functional and/or logical enterprise segments and represented the operational impact at each enterprise segment level and for the enterprise in total. It is appreciated that the equations and mathematical determinations described are provided for illustrative purposes only, and that any other mathematical operations may be utilized to indicate relative operational impact based on underlying OIIVs as calculated by the impact model. For example, in another embodiment, relative comparisons may be made between raw OIIVs of IT applications and/or enterprise segments to indicate the impact of one IT application or enterprise segment relative to other IT applications or enterprise segments. Relative comparisons between raw OIIVs may be useful if no acceptable operating range is defined, but the relative significance of an application and/or segment to the operational condition of the enterprise is desired.

### Optimizing the Enterprise

After developing the index model, and generating the OIIVs and Oily variance values for the IT applications and enterprise segments, the IT assessment system may be configured to mathematically calculate the most resourceful and effective means to improve the operational condition of the enterprise by prescribing the most effective ways to allocate resources and distribute spending. Many enterprises dedicate a portion of their budgets to IT system investment, maintenance, and upkeep. By utilizing the impact index model and mathematically evaluating the most resourceful and effective means to allocate spending, subjective practices of negotiation and non-data driven tactics that often play a part of the budgeting process can be avoided.

According to one embodiment, the enterprise optimization can be achieved by mathematically minimizing the OIIV variances, whether at the IT application level and/or at higher levels of enterprise segments. As a result, resources would be allocated to IT applications within the enterprise segments in a way that results in the smallest possible residual OIIV variance across the enterprise. Example mathematical analyses allow defining spending and resource allocation rules and constraints, and then systematically determining the most efficient way to allocate resources and spending to achieve the greatest reduction in OIIV variances based on the rules and constraints. For example, according to one embodiment, OIIV variance values and the allocation rules and constraints can be utilized to mathematically define the enterprise conditions to be optimized. If the mathematical relationships between the OIIV variance values and the rules and constraints are represented linearly, various linear programming techniques can be utilized to numerically solve the mathematical representation of the enterprise. It is appreciated that, according to various embodiments, any number of mathematical analyses, linear or non-linear, can be utilized and tailored to allow for allocation decisions to be made at various levels of enterprise abstraction (e.g., providing allocation or investment recommendations at the IT application level, process level, process chain level, etc.).

FIG. 19 illustrates a flow diagram of an example method 1900 for optimizing the enterprise, which may be performed, at least in part, by an IT assessment system, according to one embodiment. The method may begin at block 1905, in which an objective function is defined that mathematically represents the operational condition of the enterprise and the impacts each IT application (and/or enterprise segment) has on the enterprise operation, based at least in part on the OIIVs and variances determined by the IT assessment system according to the impact model described herein.

According to one embodiment, the objective function may generally be defined by one or a system of equations that represent each IT application in the enterprise and each variable that contributes impact to the enterprise (e.g., the characterizations of the IT applications, the OIIVs, and/or the OIIV variance values, etc.). Rows could be defined for each IT application and columns for each variable represented by the objective function.

For example, some columns could indicate the three types of impact (category impact, classification impact, and cost impact) each of which have values that together contribute to the total impact of the respective IT application. The impact (e.g., My or OIIV variances are utilized to represent impact), generally indicates the amount of impact the respective IT application has on the conditional health of the enterprise. The objective function thus allows calculating the amount of investment for each of these characterization or impact types—lifecycle category investment (e.g., retirement or total cost elimination, etc.), classification investment (e.g., classification factor value improvement, etc.), and cost investment (e.g., cost improvement, etc.) that would minimize the impact values. It is appreciated, however, that any number of impact values and investment types can be defined.

According to one embodiment, each investment decision may also be qualified by the year, or other planning periods (e.g., quarters, two-year periods, etc.) in which it is to be made. For example, budgeting may be performed in advance of year 1, and for a predefined number of years, such as five years, which indicates a long range or future planning period. It is possible to plan for a greater or fewer number of years, but the constraint set described herein should be adjusted accordingly (e.g., total budget available, annual spending constraints, application retirement planning, etc.). In one embodiment, it is possible to adjust the objective function and constraint set such that during different years (or other planning periods) investment spending is allocated at different levels of granularity. For example, during the early periods (e.g., at year 1), investment allocations may be made at the IT application level, while during later periods, investment allocations may be made at the low-level or higher-level enterprise segment level instead of at the individual IT application level.

In addition, one or more additional columns can be provided that contain the application operating range variance indicating the relative level of impact (outside the acceptable operating range variance) each IT application causes to the enterprise. At the intersection of the rows and columns is the amount of impact (e.g., OIIV, or “heat,” variance, etc.). The goal of the solution would be to apply resources (e.g., spending, reductions, human resources, etc.) in such a way that the overall operating range variance across the whole enterprise is minimized. It may not be desirable to reduce or increase the impact (e.g., increase or reduce the “heat” relative to a temperature index) for a single IT application more than it takes to meet or come close to the nearest boundary of the acceptable operating range. Moreover, it may not possible to reduce the impact by an amount greater than the overall impact for each IT application or enterprise segment. According to one embodiment, the objective function matrix would only represent IT applications that have an impact indicated outside the acceptable operating range (e.g., applications that are too “hot” or too “cold,” such as the example with reference to FIG. 18. Though, in other embodiments, it may be desirable to define an objective function that allows analyzing IT applications that are operating within the acceptable operating range.

Accordingly, if variables of the objective function represent the amount of investment of each impact type (e.g., retirement, classification improvement, and cost reduction) for each IT application, the objective function may essentially be defined as the sum of all current operating range variances (which is a constant) minus the amount of investment of each impact type multiplied by a constant representing the effectiveness of investment for that impact type (which is also a constant).

According to one embodiment, effectiveness (also referred to herein as “heat exchange rate”), generally provides a constant value used as a multiplier that represents the amount of improvement achievable for each dollar amount spent, or, in other words, an expected return on investment constant. For example, the same investment spent on improving one investment type (e.g., retirement, classification improvement, or cost reduction) may not generate the same reduction in the OIIV variance (e.g., reduction in “heat,” etc.). According to various embodiments, the effectiveness constant (e.g., the “heat” exchange rate) may be adjusted prior to performing a specific IT assessment, allowing tailoring of the effectiveness or return on investment. Sample effectiveness constants as they relate to category investments, classification investments, and cost investments, may be defined as, but are not limited to, a retirement effectiveness constant of 1 (e.g., for every $1 spent the OIIV variance is reduced by 1); a classification effectiveness constant of 0.0001 (e.g., for every $10,000 spent the OIIV variance is reduced by 1); and cost effectiveness constant of 0.0000667 (e.g., for every $15,000 spent the OIIV variance is reduced by 1). It is appreciated that these effectiveness constant values are for illustrative purposes only, and are not intended to be limiting.

According to one embodiment, the decision to retire an application may be subjected to additional constraints, such as, but not limited to, making an all or nothing investment to retire an IT application over the predefined assessment time frame, and that IT applications selected for retirement are not to be allocated any other types of investment, that retirement is to be completed during the predefined assessment timeframe (e.g., within five years if the long-range plan is for five years, etc.), that non-retirement investments may not exceed retirement investments over time, and/or that the only investment type to be allocated for IT applications operating within the acceptable operating range is to be the retirement investment. Application retirement may have additional constraints or may be subject to additional considerations. For example, it may be desirable to provide a constraint that forces the decision to retire an IT application when other types of investment exceed the cost of retirement. In another example, only IT applications categorized as declining may be permitted to be retired. However, the additional costs of retiring an application can also be considered, such as replacement costs (e.g., if retiring a non-declining application because declining applications are assumed to be retired), and the additional costs incurred on replacement applications (even if already in existence) as a result of the retirement of an application. Moreover, even applications having an OIIV within the acceptable operating range, which would result in an OIIV variance of zero, may still be candidates for retirement, such as if the cost of retiring the application is less than the cost of maintaining the application within the acceptable operating range. In this example, to facilitate identifying the possibility of retiring an application with an OIIV variance of zero, an optimization may be based at least in part on the raw OIIV values instead of, or in addition to, the OIIV variance values, which would allow identifying OIIV reduction even when within the acceptable operating range. These and various other similar constraints and rules may be defined as part of the constraint set for any of the investment types, as performed at block 1910.

Thus, defining and solving an objective function that is based on the objectively generated impact index values, and considering these and other similar business objectives, such as to minimize the variances that represent the operational impact across the enterprise, will in turn arrive at the most effective investments and resource allocation recommendations to improve the operational condition of the enterprise.

Following block 1905 is block 1910, in which a number of constraints to solving the objective function are defined. According to various embodiments, the constraints may relate to IT application level constraints, enterprise segment level constraints, enterprise-wide constraints, and the like, many of which are discussed above with reference to block 1905. Constraints may include, but are not limited to, variable thresholds; variable limits; variable non-negativity; time-based constraints (e.g., long-range plan timelines, individual year spending constraints, application retirement, application ramp-up, etc.); spending and investment amount constraints (e.g., total investment limit, individual process chain, process, and/or IT application investment limits, investment limits per year, etc.); relationships between variables (e.g., relative amount of influence or spending of one application and/or segment versus another, etc.); application retirement considerations; other lifecycle considerations (e.g., ramp-up, etc.); relative level of influence one investment type (e.g., retirement, category improvement, or classification improvement, etc.) has on reducing the variance (e.g., $10 k investment=1 degree reduction, etc.); political or fairness considerations (e.g., the “fairness” of equitably allocating investments and resources to the various enterprise segments, etc.); chronological or yearly investment considerations (e.g., that an enterprise segment and/or IT application is not neglected during two consecutive years, accounting for different costs or other constraints for different investment years 1−n, etc.); legal constraints (e.g., regulatory or statutory limits on limited or forced spending, etc.); other third-party constraints (e.g., limits on or forced spending based on third-party influences, such as industry groups, partners, etc.); costs of not doing projects; future benefits; future costs; and/or application investment and/or operation interdependencies. It is appreciated that any type and number of constraints can be defined that will represent an enterprise's spending and resource allocation goals and limitations, according to various embodiments.

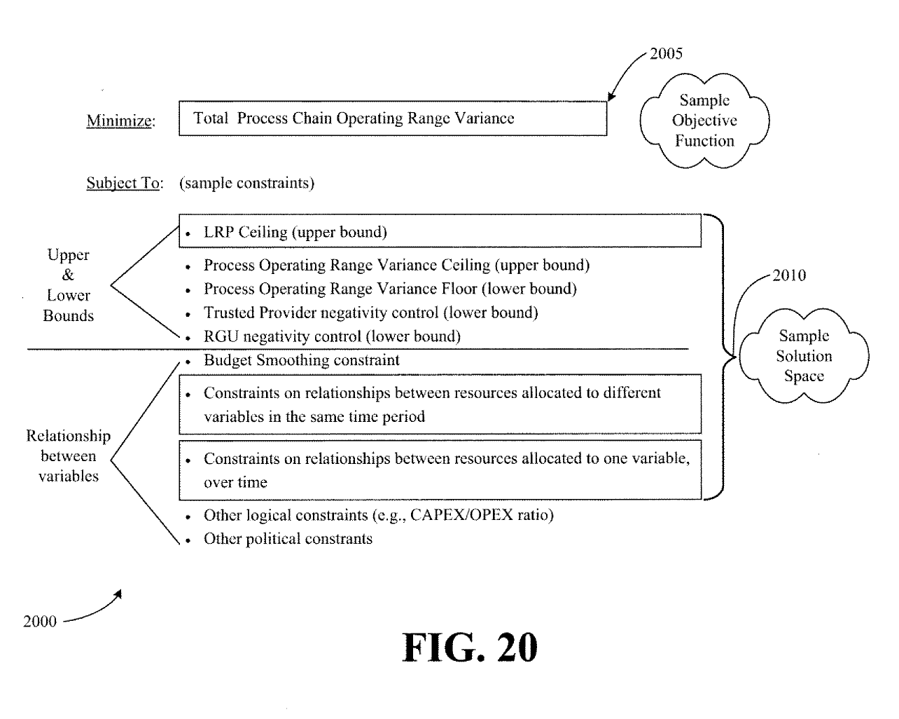

FIG. 20 illustrates a simplified statement of an objective function 2005—one defined to minimize the total process chain variance, where the term “total process chain variance” may interchangeably refer to the enterprise-wide variance determined by summing individual process chain variances. FIG. 20 also illustrates a simplified set of sample constraints 2010, showing upper bounds, lower bounds, and variable relationships.

Following block 1910 is block 1915, in which the IT assessment system mathematically solves the objective function according to the provided rules and constraints. The IT assessment system can be configured to execute any number of mathematical analyses to solve the objective function and identify an optimum (or improved) solution to the objective function, including, but not limited to, linear programming techniques (e.g., the Simplex Algorithm or the Hungarian Method, etc.), ranking, integer programming (e.g., the branch and bound method, etc.), non-linear programming (e.g., if interdependencies exist between variables, such as variables that multiply or divide on other variables, etc.), and the like.

According to one embodiment, the objective function may be solved utilizing the Simplex Algorithm, for which a “starting matrix” is formulated. A starting matrix represents the objective function and the simultaneous equations that constrain the solution. The starting matrix is created according to the rules of the Simplex Method and combines the objective function variables and those constraint equations that relate the objective functions to each other and to other controlling values (limits, thresholds, non-negativity, etc.). The solution to the problem is the set of values assigned to each objective function variable. In the examples described herein, the objective function value, which refers to the sum of all the values assigned to objective function variables, can be the OIIV variance for the enterprise (e.g., the number of degrees above or below an acceptable operating range).

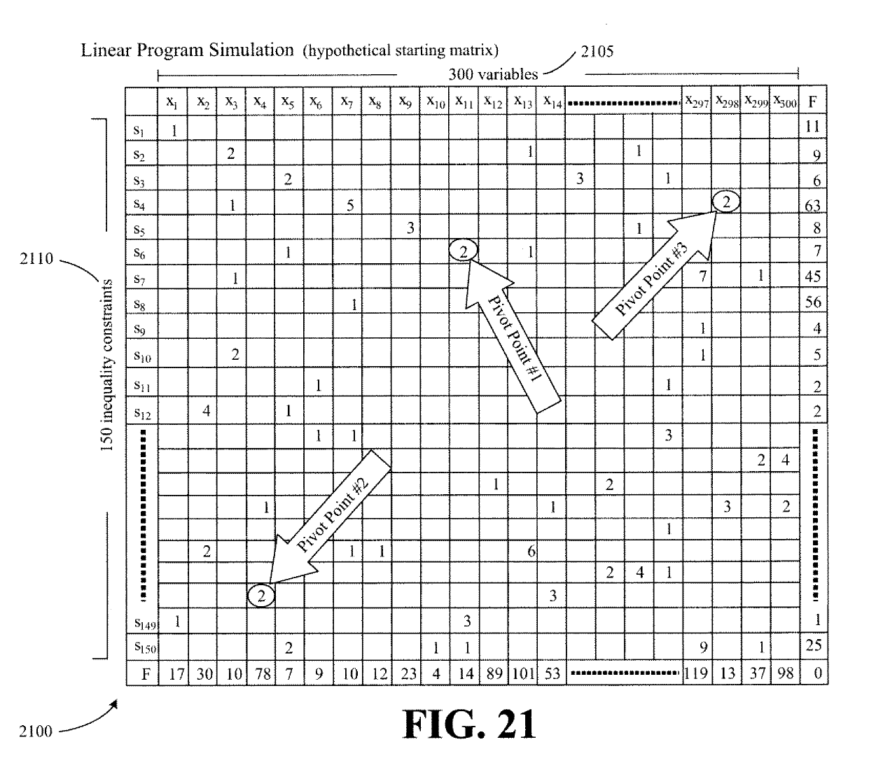

FIG. 21 illustrates an example starting matrix 2100 for solving the objective function by the Simplex Method, according to one embodiment. The “x” variables 2105 across the top of the starting matrix 2100 represent the objective function variables. The solution contains a unique value for each x variable, and the complete set of x variables is the solution to the complete problem of optimizing the objective function value. As used herein, optimizing may generally refer to improving, maximizing, minimizing, etc., depending on the formulation of the objective function and the desired assessment goals. According to one embodiment, as described above, the values for each of the “x” variables 2105 represent the amount of investment at the application level, by type of investment (e.g., improving category impact, improving classification impact, and improving cost impact), as well as optionally by the year of investment, such as if a multiple year analysis is being performed.

The “s” variables 2110 across the left-hand side of the starting matrix 2100 represent the “slack” variables. Because most real-life constraints are inequalities (e.g., greater than, less than, etc.), slack variables allow converting the constraints to equalities. Although not represented by the example matrix 2100, in some embodiments, a starting matrix may include “artificial” or “a” variables, which are introduced when a basic solution to the linear program is not apparent. Introducing artificial variables allows putting the constraint equations in “canonical form,” which may be called for when performing the Simplex Method. The example starting matrix 2100 also displays example values within the matrix and pivot points, illustrating the intermediary stages of iterating toward a solution.

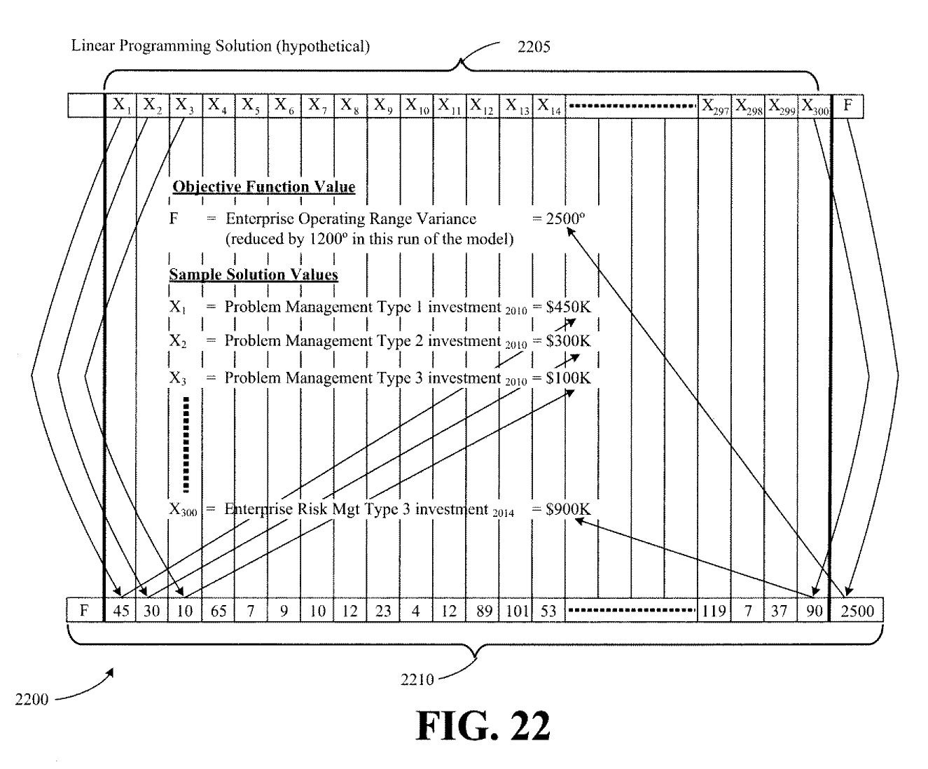

FIG. 22 illustrates an example solution 2200 to the objective function, such as may be obtained by the IT assessment system applying the example starting matrix of FIG. 21. According to this example embodiment, the optimized solution to the objective function was to reduce the enterprise variance to 2500° F. (from approximately 3700° F.). Again, the “x” variables 2205 across the top represent the objective function variables. The “x” variable solution values 2210 across the bottom represent the solution for each of the “x” variables 2205, and directly correspond to the investment and resource allocation recommendations. For example, the first “x” variable solution value 2210 of 45 correlates to a recommendation to spend $450,000 on the first investment type represented by the objective function's first “x” variable 2205. Similarly, the last “x” variable solution value 2210 of 90 correlates to a recommendation to spend $900,000 on the last investment type represented by the objective function's last “x” variable 2205.

It is appreciated that the objective function and solution representations in FIGS. 21 and 22 are provided for illustrative purposes only, and that, according to various embodiments, the mathematical approach and solution may differ, depending on the goals and nature of the enterprise. The aforementioned mathematical analyses are not intended to be limiting, but to provide an illustrative example of only one of many possible mathematical techniques for optimizing (or improving) a known set of relationships, variables, and values.

With continued reference to FIG. 19, following block 1915 is block 1920, in which an investment and resource allocation recommendation is provided according to the solution determined at block 1915. According to one embodiment, the IT assessment system can generate a report, roadmap, or other output providing recommendations, and the relative impact or improvement implementing the recommendations are expected to have, on the enterprise according to the IT assessment. Moreover, according to one embodiment, the recommendations may be grouped or added according to enterprise segmentation. For example, the recommendations on spending and resource allocation may be made at the process level or at the process chain level, or, in another embodiment, made according to other enterprise segments (e.g., per affinity group, per enterprise division, per operational group, etc.).

The method 1900 may therefore end after block 1920, having determined investment and resource allocation recommendations based on a mathematical analysis and optimization of the current enterprise operational condition.

Accordingly, by basing the mathematical model and analyses on the relative impact each application has on the enterprise, where that relative impact is determined by objectively gathering data for each application and generating a model of relative impact (e.g., the OIIV) of each application, subsequent optimization and improvement analyses can be performed to base spending and resource allocation on the underlying objective representation of the enterprise condition. Controlling the definition of the index model and applying the same model to all applications limits solution skewing. Moreover, the configurable nature of the impact index model, such as the “on/off switch” and the weighting capabilities, allows for a dynamic view of the enterprise currently and into the future. Finally, the results of the optimization indicate a definite mathematical solution representing investment and resource allocation where it will have the most benefit to the enterprise.

The systems and methods described herein can therefore be utilized to provide system architectural vision and guidance, investment strategies for IT systems and applications, and investment standards. The impact index model allows establishing a clear understanding of the current state of an enterprise and its IT systems and applications based on objectively gathered and quantified metrics. By generating an impact representation of the relative impact of each IT application, and the enterprise segments with which each is associated, the enterprise operational condition is represented simply and effectively. Moreover, by using real-world metaphors to indicate the relative impact to the enterprise, logical conclusions can be drawn quickly, still based on the underlying objectively defined impact model. Furthermore, graphical representations (e.g., “heat mapping” or “friction,” etc.) further simplify indicating the areas of the enterprise that may need attention, and how much attention may be needed relative to other areas and/or other IT applications.

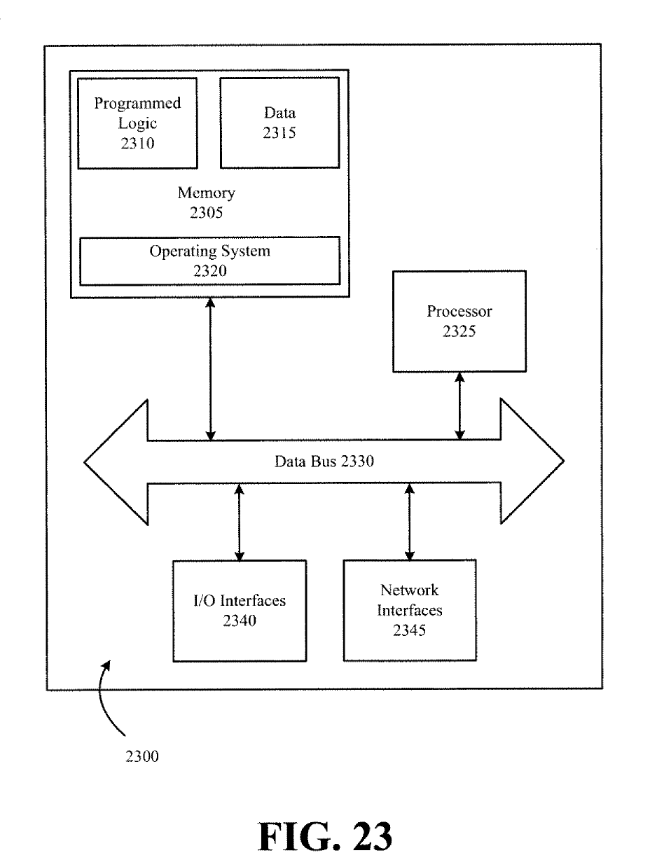

Any or all of the previously described methods and operations can be performed by an IT assessment system, which may be embodied as a computer or a system of computers. FIG. 23 illustrates an example computer 2300, which may be one or more processor-driven devices, such as, but not limited to, a server computer or computers, a personal computer or computers, a handheld computer or computers, a network-based computer or computers, and the like. In addition to having one or more processors 2325, each computer 2300 may also further include one or more memories 2305, one or more input/output (“I/O”) interfaces 2340, and one or more network interface(s) 2345. All of these components may be in communication over a data bus 2330. The memory 2305 may store data 2315 (such as the IT application data and characterizations, enterprise segment definitions, optimization rules and constraints, assessment results, etc.), various program logic 2310 (such as the programming logic for implementing the index model and the optimization operations, etc.), and an operating system (“OS”) 2320. In addition, in some embodiments, the memory 2305 may further store a client and/or host module for accessing other computer devices and/or allowing access to the computer 2300. The memory may further store a database management system (“DBMS”) for accessing one or more databases or other data storage devices, which may optionally be operative for storing any of the aforementioned data and/or programming logic. The I/O interface(s) 2340 may facilitate communication between the processor 2325 and various I/O devices, such as a keyboard, mouse, printer, microphone, speaker, monitor, and the like. The network interface(s) 2345 may take any of a number of forms, such as, but not limited to, a network interface card, a modem, a wireless network card, and the like. It is appreciated that any number of computer devices may be used to implement the methods and operations described herein, and that the preceding description is provided for illustrative purposes only.

Various block and/or flow diagrams of systems, methods, apparatus, and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for representing information technology impact on an enterprise, comprising:
characterizing, by an IT assessment system comprising one or more computers, each of a plurality of information technology (IT) applications according to a plurality of factors; and
generating, by the IT assessment system, an operational impact index value (OIIV) for each of the plurality of IT applications based at least in part on the characterization of the respective IT application;
wherein each OIIV relates to an impact index scale representing a relative impact of the respective IT application on the enterprise.

2. The method of claim 1, wherein the plurality of factors includes at least one of: (a) an IT application lifecycle categorization; (b) an IT application influence classification; or (c) an associated IT application cost.

3. The method of claim 1, wherein at least one of the plurality of factors is further based on one or more sub-factors related to the at least one of the plurality of factors.

4. The method of claim 1, further comprising applying a weighting value to at least one of the plurality of factors, or at least one sub-factor associated with at least one of the plurality of factors, for each of at least a subset of the plurality of IT applications, wherein the weighting value impacts the relative influence of the respective factor on the OIIV generated for each of the subset of the plurality of IT applications.

5. The method of claim 1, wherein generating the OIIV for each of the plurality of IT applications comprises mathematically operating on individual values associated with each of the plurality of factors for the respective IT application.

6. The method of claim 1, further comprising generating an enterprise level My based at least in part on the OIIV for each of the plurality of IT applications.

7. The method of claim 1, further comprising:
grouping each of the plurality of IT applications into one or more enterprise segments selected from a plurality of enterprise segments; and
generating a segment level OIIV for each of the plurality of enterprise segments based at least in part on the OIIV for each of the plurality of IT applications grouped with the respective enterprise segment.

8. The method of claim 7, wherein each of the plurality of enterprise segments represents a different process function performed by the enterprise, and wherein each segment level OIIV represents a process level OIIV.

9. The method of claim 7, wherein the plurality of enterprise segments represents a plurality of low-level enterprise segments and each of the segment level OIIVs represents a low-level segment OIIV, and further comprising:
grouping each of the low-level enterprise segments into a higher-level enterprise segment selected from a plurality of higher-level enterprise segments; and
generating a higher-level segment OIIV for each of the plurality of higher-level enterprise segments based at least in part on the low-level segment OIIV for each of the low-level enterprise segments grouped with the respective higher-level enterprise segments.

10. The method of claim 9, wherein each of the plurality of higher-level enterprise segments represents a different process chain representing a group of related process functions, and wherein each of the higher-level segment OIIVs represents a process chain level OIIV.

11. The method of claim 9, further comprising applying a weighting value to at least one of the plurality of low-level segment OIIVs when generating the higher-level segment OIIV, wherein the weighting value impacts a relative influence of the at least one of the plurality of low-level segment OIIVs or the higher-level segment OIIV.

12. The method of claim 9, further comprising generating an enterprise level OIIV based at least in part on one of: (a) a sum of the low-level segment OIIVs; or (b) a sum of the higher-level segment OIIVs.

13. The method of claim 12, further comprising applying a weighting value to at least one of the plurality of low-level segment OIIVs or at least one of the plurality of higher-level OIIVs when generating the enterprise level OIIV, wherein the weighting value impacts a relative influence of the at least one of the plurality of low-level segment OIIVs or the at least one of the plurality of higher-level OIIVs when generating the enterprise level OIIV.

14. The method of claim 1, further comprising defining an acceptable operating range along the impact index scale representing a relative impact of the respective IT applications on the enterprise.

15. The method of claim 14, further comprising determining variances between the OIIV of each IT application and one of an upper bound or a lower bound of the acceptable operating range.

16. The method of claim 15, wherein each variance represents a relative level of impact of the respective IT application to the enterprise, wherein a greater variance represents a greater relative level of impact.

17. The method of claim 1, further comprising generating IT application investment recommendations for the enterprise based at least in part on the OIIV for at least a subset of the plurality of IT applications.

18. The method of claim 17, wherein generating IT application investment recommendations further comprises:
defining a plurality of IT investment constraints representing mathematical or logical constraints to the IT application investment recommendations; and
mathematically determining the IT application investment recommendations based at least in part on the IT investment constraints and the OIIVs.

19. The method of claim 18, wherein mathematically determining the IT application investment recommendations further comprises:
determining an objective function associated with the IT investment constraints and the OIIV of each of the plurality of IT applications; and
solving the objective function utilizing linear equations.

20. The method of claim 18, wherein mathematically determining the IT application investment recommendations comprises reducing a variance between at least one OIIV and an acceptable operating range for: (a) one or more of the plurality of IT applications; or (b) one or more enterprise segments with which one or more of the plurality of IT applications are grouped.

21. The method of claim 18, wherein the plurality of IT investment constraints comprises one or more of: (a) one or more investment types; (b) an overall investment limit; (c) an investment parameter associated with one or more IT applications or enterprise segments; (d) IT application retirement parameters; (e) IT application lifecycle parameters; (f) investment schedules over a plurality of years; or (g) one or more investment levels dependent upon investment levels for one or more other IT applications or enterprise segments.

22. The method of claim 1, wherein the impact index scale representing a relative impact of the IT applications on the enterprise is represented by a temperature scale, and wherein each operational impact index value is represented by a temperature along the temperature scale.

23. The method of claim 1, wherein the impact index scale representing a relative impact of the IT applications on the enterprise is represented by a spectrum of hues, and wherein each operational impact index value is represented by a hue along the spectrum of hues.

24. A system for representing information technology impact on an enterprise, comprising:
a memory operable to store computer-executable instructions;
a processor in communication with the memory and operable to execute the computer-executable instructions to:
characterize each of a plurality of information technology (IT) applications according to a plurality of factors; and
generate an operational impact index value (OIIV) for each of the plurality of IT applications based at least in part on the characterization of the respective IT application, wherein each Oily relates to an impact index scale representing a relative impact of the respective IT application on the enterprise.

25. The system of claim 24, wherein the processor is further operable to execute the computer-executable instructions to:
associate each of the plurality of IT applications with one or more enterprise segments selected from a plurality of enterprise segments; and
generate a segment level OIIV for each of the plurality of enterprise segments based at least in part on the OIIV for each of the plurality of IT applications grouped with the respective enterprise segment.

26. The system of claim 24, wherein the processor is further operable to execute the computer-executable instructions to generate an enterprise level OIIV based at least in part on the OIIV for each of the plurality of IT applications.

27. The system of claim 24, wherein the processor is further operable to execute the computer-executable instructions to generate IT application investment recommendations for the enterprise based at least in part on a mathematical optimization of a mathematical representation based on the OIIV of at least a subset of each of the plurality of IT applications.

28. The system of claim 24, wherein the processor is further operable to execute the computer-executable instructions to cause a display of at least one of: (a) a plurality of hues, each hue representing the OIIV or an OIIV variance calculated for a respective one of the plurality of IT applications; or (b) a plurality of temperature values, each temperature value representing the OIIV or an OIIV variance calculated for a respective one of the plurality of IT applications.

29. A computer program product, comprising a computer usable medium having computer-executable instructions embodied therein, said computer-executed instructions operable for representing information technology impact on an enterprise by:
characterizing each of a plurality of information technology (IT) applications according to a plurality of factors; and
generating an operational impact index value (OIIV) for each of the plurality of IT applications based at least in part on the characterization of the respective IT application;
wherein each OIIV relates to an impact index scale representing a relative impact of the respective IT application on an enterprise.
